(19) United States
(12) Patent Application Publication
(10) Pub. No.: US 2019/0041143 A1
(43) Pub. Date: Feb. 7, 2019

(54) HEAT DISSIPATION SYSTEM USING SINGLE-PHASE, SUPERCRITICAL FLUID

(71) Applicant: INTEL CORPORATION, Santa Clara, CA (US)

(72) Inventors: Mark Angus MacDonald, Beaverton, OR (US); Yoshifumi Nishi, Aloha, OR (US)

(73) Assignee: Intel Corporation, Santa Clara, CA (US)

(21) Appl. No.: 15/939,164

(22) Filed: Mar. 28, 2018

(51) Int. Cl. F28F 9/22; F25B 40/00; F25B 9/00; F28F 1/12; F28D 15/04; F28D 15/02; C09K 5/04; F28F 9/00

(52) U.S. Cl. CPC F28F 9/22; F25B 40/00; F25B 9/008; F28F 1/128; F28D 15/043; F28F 2215/04; C09K 5/041; F28F 9/005; F25B 2309/061; F28F 2215/02; F28D 15/0275

(57) ABSTRACT

In one aspect, an apparatus comprises a housing forming an internal cavity and a supercritical fluid enclosed in the internal cavity. The housing is configured to thermally couple to a heat-generating component. The supercritical fluid comprises a fluid in a supercritical state. In addition, the supercritical fluid is configured to transfer heat away from the heat-generating component.

### TECHNICAL FIELD

Embodiments described generally relate to the field of temperature control systems and more particularly to devices for dissipating heat using a single-phase, supercritical fluid.

### BACKGROUND

Many devices (e.g., electrical devices, mechanical devices, and/or electromechanical devices) generate heat during operation. Such devices can include, for example, a mobile phone, a computer, a set top boxes, an automobile, an aircraft, manufacturing equipment. In many cases, the generated heat must be dissipated to prevent the device (and/or the components therein) from overheating.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1, 2A, 2B, 3A, and 3B illustrate various views of a heat-transfer device comprising a supercritical fluid for cooling a heat generating component, according to some embodiments of the present disclosure;

FIG. 4 is a graph of density variation for several fluids, according to some embodiments of the present disclosure;

FIGS. 5, 6, 7, and 8 illustrate various views of another heat-transfer device comprising a supercritical fluid and fins for cooling a heat generating component, according to some embodiments of the present disclosure;

FIGS. 9, 10, and 11 illustrate various views of another heat-transfer device comprising a supercritical fluid and structural members for cooling a heat generating component, according to some embodiments of the present disclosure;

FIG. 12 is a plan view of a heat-transfer device comprising a supercritical fluid, fins, and structural members, according to some embodiments of the present disclosure; and

FIGS. 13, 14, and 15 illustrate various views of a heat-transfer device comprising structural members, according to some embodiments of the present disclosure;

FIG. 16 is an isometric view of a heat-transfer device comprising one or more pipes for transporting a supercritical fluid, according to some embodiments of the present disclosure;

FIG. 17 is an isometric view of another heat-transfer device comprising one or more pipes for transporting a supercritical fluid, according to some embodiments of the present disclosure; and

FIG. 18 is a simplified component diagram illustrating components of a computing device comprising one or more heat-transfer devices.

### DESCRIPTION OF EMBODIMENTS

A device may include one or more heat-generating components. A heat-generating component generates heat during its operation. For example, a heat-generating component can comprise a processor, a power source (e.g., battery), a power converter, a sensor, mechanical component (e.g., a piston), a component operably coupled to circuit board, and/or any other device or component (electrical and/or mechanical). One technical problem for such devices is that the generated heat must be dissipated to prevent the device (and/or the components therein) from reaching a limiting temperature (e.g., a temperature at which the device and/or component stops functioning or its functioning is impaired (e.g., reduced efficiency)). The devices generate more heat than they can dissipate without assistance from a cooling system.

Heat-transfer systems are used to cool such devices and/or components by transferring heat away from heat-generating components. Such heat-transfer systems dissipate the heat by, e.g., rejecting some of the heat to the ambient environment and converting some of the heat to other forms of energy (such as kinetic energy) along the way (e.g., due to the law of conservation of energy). A heat-transfer system has a thermal resistance that quantifies its ability to transfer heat (i.e., its resistance to heat flow). Thermal resistance is measured, e.g., in degrees (e.g., Celsius (C) or Kelvin (K)) per watt (e.g., ° C./W or K/W). The thermal resistance relates the power (watts) input to the heat-transfer system to a difference in temperature (measured in ° C. or ° K) that results from the heat resistance of the heat-transfer system. The difference in temperature is measured between a heat source location and a heat rejection location. For each of a range of power inputs, the heat-transfer system produces a temperature difference value. For heat-transfer systems using solid conductors (e.g., aluminum, graphite, and the like), the thermal resistance is substantially linear as the power increases (e.g., a plot of the thermal resistance over a range of values has a linear slope).

In some heat-transfer systems, a “working” fluid is used to absorb and transfer heat away from the heat-generating component. For example, some heat-transfer systems use water, both liquid and vapor, (as the working fluid) and a wick to transport the water. In such systems, the dissipation of heat (i.e., cooling) relies on the water (i.e., the working fluid) changing phase. The water undergoes a phase change between a liquid state (i.e., liquid water) and a gaseous state (i.e., water vapor).

A vapor chamber is an example of a heat-transfer system and includes a chamber that encloses liquid water and water vapor. For example, under typical operating conditions, the chamber may have about 10% (of its total volume) filled with liquid water and the remaining 90% filled with water vapor. While the percent filled with liquid water can vary between devices and also vary with temperature, the percent is generally small (e.g., in a range of about 2% to 20%). The vapor chamber also includes a wick (within the chamber) that transports the liquid water to a location in the chamber (i.e., a hot spot) where the liquid water absorbs heat from the heat-generating component and, thereby, is evaporated to water vapor (i.e., the gaseous state). The water vapor moves to a location in the chamber (i.e., a cool spot) where it releases heat and condenses (again) to liquid water. Such movement is driven by the evaporation itself (e.g., expanding water vapor needs to move out of the way) and capillary forces on the liquid water within the wick. The wick is used to transport the condensed liquid water from the cool spot to the hot spot. The wick absorbs the liquid water and capillary forces (e.g., capillary action) return the liquid water to the hot spot (where the liquid water is again evaporated to water vapor). When the vapor chamber is properly functioning, the wick remains moist because the wick receives liquid water at approximately the same rate that the wick evaporates the liquid water to water vapor. These two-phase heat-transfer systems rely on the fluid (i.e., the working fluid) changing phase between a liquid state and a gaseous state.

A challenge with such two-phase heat-transfer systems is that the wick imposes a limit on an amount of power that the heat-transfer systems can handle and still properly function. For example, a vapor chamber can properly cool a heat generating component only when operated within a specific range power. When operated within the specific range power, the wick receives liquid water at approximately the same rate that the wick evaporates the liquid water to water vapor and, therefore remains moist. However, as the power increases (beyond the specific range power), the wick is unable to draw in the liquid water fast enough to keep up with evaporation. When operated above the specific range power, over time, an area of the wick around the hot spot runs dry and no liquid water is available in the area to absorb the heat from the heat generating component. In general, wick dry-out occurs when the vaporization rate exceeds the wick transport rate. The wick drying out can cause a sharp increase in thermal resistance, which often leads to cooling failure and possibly thermal runaway. As a result, the wick drying out can cause the temperature of the vapor-chamber to increase (i.e., to overheat) because the vapor chamber is no longer effectively spreading the heat that it receives from the heat-generating component. Because the vapor chamber is no longer effectively spreading the heat, any heat-generating component coupled to the vapor chamber may also overheat. This can create a snowball effect (e.g., thermal runaway), which results in the vapor chamber and the heat-generating components overheating. Such overheating can render the vapor chamber potentially harmful to any heat-generating components that it is intended to cool and, ultimately, can cause a catastrophic failure of the vapor chamber, the heat-generating components, and/or any device in which the heat-generating components are located.

Like other heat-transfer systems, each vapor chamber has a specific thermal resistance. However, vapor chambers often have a thermal resistance that is non-linear due, at least in part, to wick dry-out (e.g., as described above). Consider the following example of a vapor chamber with a non-linear thermal resistance: 1 W of power applied to the vapor chamber results in a temperature difference of 1° C.; 2 W of power results in a temperature of 2° C., 3 W of power results in a temperature difference of 3° C., . . . , and 9 W of power results in a temperature difference of 50° C. If the thermal resistance in this example were linear, the 9 W of power input would result in a temperature difference of 9° C. instead of the 50° C. actually experienced in this non-linear regime. In this example, the thermal efficiency of the system dramatically changes (i.e., drops off) based on the abrupt change in thermal resistance. This drop-off in thermal efficiency (and/or non-linearity in thermal resistance) may correspond to the onset of wick dry-out. Thus, the wick imposes a limit on an amount of power that the heat-transfer systems can handle and still properly function. In this example, the limit may be about 8 W, since operating the vapor chamber at 9 W could cause wick dry-out. Thus, manufacturers of vapor chambers often specify a maximum heat transfer rate (QMax) for the vapor chamber. The maximum heat transfer rate is a power limit below which the vapor chamber can properly function and above which the vapor chamber will malfunction.

Another challenge with such two-phase heat-transfer systems is that the wick limits the length of the heat-transfer systems. In particular, a mass flow rate of liquid water through the wick restricts the length of the wick and therefore, restricts the size of the heat-transfer system (since the wick spans between the cool spot and the hot spot). If the length of the wick gets too long (i.e., because the vapor chamber is large), the wick will be ineffective for transporting the liquid water from the cool spot to the hot spot at a rate that is fast enough to keep up with evaporation (e.g., due to the mass flow rate of liquid water through the wick being slower than the rate of evaporation to water vapor). Gravitational forces (i.e., weight) increase with height of such heat-transfer systems. The length (, which can be the height when vertically oriented) limits capillary pumping by the wick. Thus, for vertical orientations, such heat-transfer systems have a height limit below which the capillary force in the wick properly functions to transport the liquid water to the hot stop and above which the gravitational forces completely overcome the capillary force in the wick and the wick can no longer transport the liquid water to the hot stop. In practice, such two-phase heat-transfer systems using wicks are generally limited to about 6-8 inches from the hot spot to an extreme edge of the system. A potential solution to the mass flow rate issue is to actively pump liquid water to the hot spot. Such a potential solution is generally only practical with extremely well-controlled settings (e.g., in research labs) and is prohibitively complex and expensive to implement in relatively uncontrolled settings, which renders the solution impractical for non-lab situations (e.g., in consumer computing devices). Moreover, such active pumping requires a supply of power, which if the power were lost, could cause the heat-transfer system to fail to dissipate the requisite heat to prevent a device (and/or heat-generating components therein) from reaching a limiting temperature.

A potential solution to such two-phase heat-transfer systems is a single-phase heat transfer system. For example, air and/or liquid water (e.g., at atmospheric pressure) can be used to cool heat-generating components. However, passive (i.e., non-pumped) systems (e.g., thermosiphons) using air and/or liquid water are, in general, ineffective and/or inefficient. Air has a relatively low thermal mass. Thus, a cooling system that uses air as the primary working fluid could require a large volume of air (and/or high-turnover of the air) to absorb and dissipate heat. Liquid water has a relatively high thermal mass. Thus, a cooling system that uses liquid water as the primary working fluid could effectively absorb heat. However, in some temperature ranges, the density of liquid water does not change very much based on small changes in temperature (i.e., low buoyant forces). This means that the liquid water may not circulate as much as needed to dissipate the heat. For example, a thermosiphon using liquid water (e.g., at atmospheric pressure) may fail to dissipate heat because the liquid water is not buoyant enough to drive circulation of the liquid water. Though liquid water has the requisite thermal mass to absorb heat, it is not buoyant enough to dissipate the heat without active circulation (e.g., pumps). Though air may have the requisite buoyancy to dissipate the heat without active circulation, it lacks the thermal mass needed to absorb heat.

A solution to the above identified challenges (and others) presented herein includes a heat-transfer device comprising a housing forming an internal cavity and enclosing, in the internal cavity, a fluid in a supercritical state (i.e., a supercritical fluid). The supercritical fluid is neither liquid, nor gas, nor solid. The heat-transfer device is passive and does not require a power supply for its operation. The supercritical fluid circulates within the internal cavity based on temperature changes (which result in changes in density of the supercritical fluid). The fluid is configured to transfer heat away from a heat-generating component while remaining in the supercritical state. In some examples, one or more members (e.g., structural members and/or fins) within the internal chamber provide structural support to the housing and/or to control the circulation of the supercritical fluid within the internal cavity.

The heat-transfer device does not require a power supply for its operation. Advantageously, the lack of active circulation (e.g., no direct power, no pumps) enables the heat-transfer device to operate in low power devices. Low power devices may use, for example, 5 W of power or less. The heat-transfer device does not rely on power to dissipate heat and, therefore, does compete with other components for power. The fluid remains in the supercritical state during operation of the heat-transfer device. The internal cavity is filled with a single-phase supercritical fluid. The heat-transfer device lacks any wick (as is needed for some two-phase heat-transfer systems). The heat-transfer device overcomes challenges associated with wicks (e.g., wick dry-out, limits on power of the two-phase heat-transfer systems, limited size). Advantageously, due in part to the thermal mass and buoyance of the supercritical fluid, the heat-transfer devices of the present disclosure can operate at much higher heat transfer rates than some two-phase heat-transfer systems. This is due in part to the fact that (e.g., for any given design thickness/size range) two-phase heat-transfer systems will always have some wick dry-out limit (e.g., Qmax), but the heat-transfer devices of the present disclosure do not have such a limitation. Although, there is (theoretically) no limit to height for heat-transfer devices of the present disclosure, some embodiments may have a pressure limit and/or a temperature limit based on structural integrity (e.g., a max. pressure and/or temperature that the heat-transfer device can withstand without failure). Advantageously, the heat-transfer device can provide passive cooling optimization over a large surface area (e.g., length/width of 3-36 inches) while remaining thin (e.g., 6 mm or less). As an illustrative example, some heat-transfer devices of the present disclosure are large enough to provide cooling-tower sized solutions).

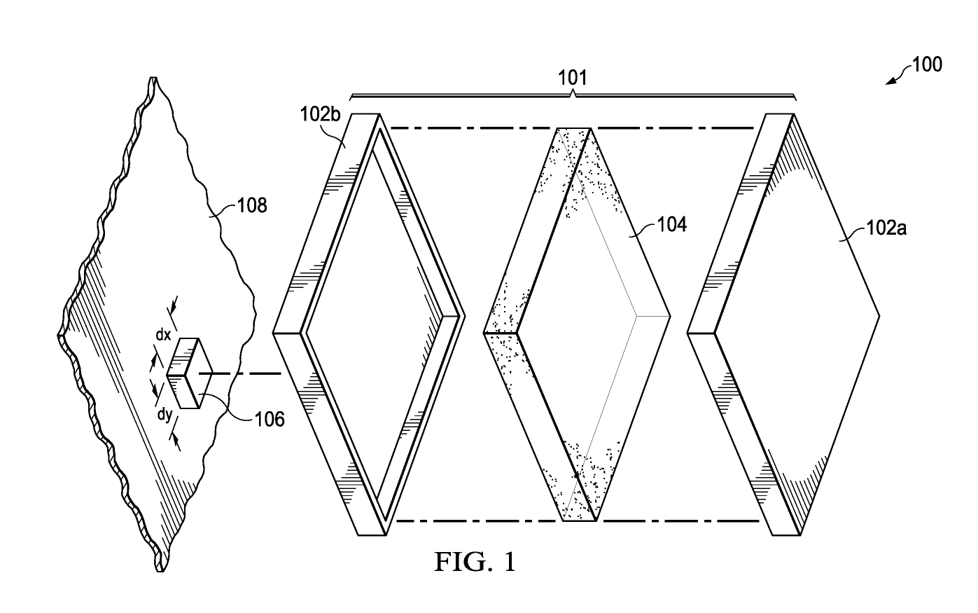

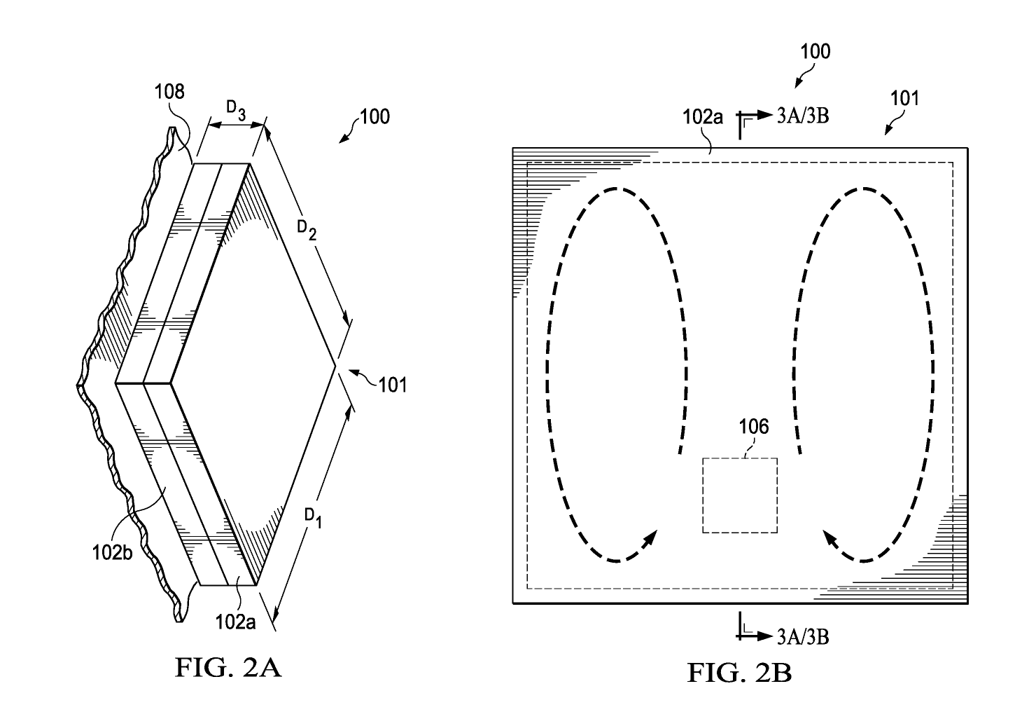

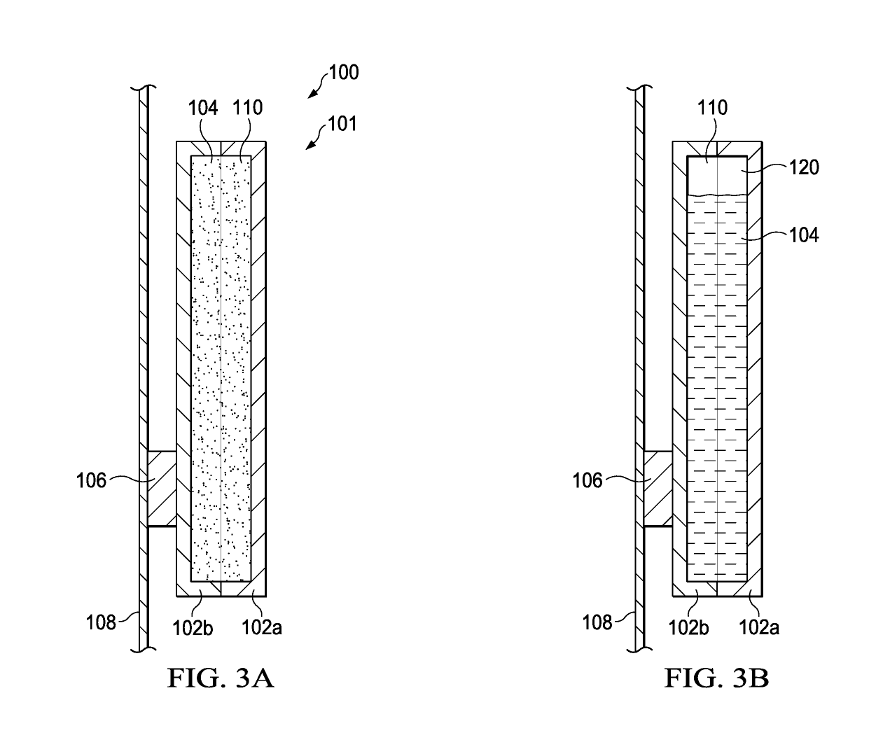

FIGS. 1, 2A, 2B, 3A, and 3B illustrate various views of a system 100 comprising a heat-transfer device 101 for cooling a heat-generating component 106, which is coupled to a circuit board 108, according to some embodiments of the present disclosure. FIG. 1 is a partially exploded diagram of the system 100. FIG. 2A is an isometric diagram of the system 100 in which the heat-transfer device is assembled and coupled to the heat-generating component 106. FIG. 2B is a plan view of the system 100 (e.g., looking down from above the heat-transfer device 101). FIGS. 3A and 3B are sectional views of the system 100 in which the heat-transfer device 101 is coupled to the heat-generating component 106 (e.g., from a viewpoint as generally indicated by the section lines labeled “3A/3B” in FIG. 2B). FIG. 3A shows the heat-transfer device 101 when the fluid is in a supercritical state. FIG. 3B shows the heat-transfer device 101 when the fluid is not a supercritical state.

The heat-transfer device 101 comprises a housing and a supercritical fluid 104. The housing comprises a first portion 102a and a second portion 102b. The housing forms an internal cavity 110, which encloses the supercritical fluid 104. The supercritical fluid 104 substantially fills the internal cavity 110 and contacts surfaces of the internal cavity 110. The first portion 102a and the second portion 102b are attached by an attachment mechanism, which seals closed the internal cavity 110. The housing (e.g., the first portion 102a and the second portion 102b) are made of a rigid material capable of withstanding high pressures and/or high temperatures. In some examples, the housing is made of a metallic material (e.g., steel (e.g., stainless steel), aluminum, alloy, or any other metal). The rigid material is compatible with the supercritical fluid (e.g., stainless steel may be used in heat-transfer devices containing supercritical carbon dioxide due to compatibility between stainless steel and supercritical carbon dioxide). The heat-transfer device 101 uses the supercritical fluid 104 to cool the heat-generating component 106, which in this case is mounted on and electrically coupled to the circuit board 108. The supercritical fluid 104 comprises a fluid in a supercritical state. A temperature of the fluid and a pressure of the fluid are both above a critical point of the fluid. For example, the temperature of the fluid is both above a critical temperature of the fluid and the pressure of the fluid is both above a critical pressure of the fluid.

The heat-transfer device 101 is a “two-dimensional” heat-transfer device that spreads heat over a larger area than the area of the heat-generating component 106 in contact with the heat-transfer device. Turning to FIGS. 1 and 2A, the heat-transfer device 101 receives heat from the area of the top surface of the heat-generating component 106 (i.e., a first area equal to dx*dy, as labeled in FIG. 1) and transfers at least a portion of the heat through the heat-transfer device to a remaining surface area of the heat-transfer device 101 (i.e. a second area equal to [2(D1*D2+D1*D3+D2*D3)−dx*dy]). Thus, in operation, the heat-transfer device 101 increases the surface area over which heat (generated by the heat-generating component 106) is dissipated. In addition, the heat-from the heat-generating component 106 is also converted to other forms of energy by the heat-transfer device 101 (e.g., kinetic energy of the supercritical fluid 104 and the like).

FIG. 3A illustrates an example operation of the heat-transfer device 101 while dissipating from the heat-generating component 106. In this example, the heat-transfer device 101 is positioned proximate (i.e., in direct contact with) the heat-generating component 106. The heat-transfer device 101 absorbs heat from and transfers the heat away from the heat-generating component 106 using the housing (i.e., the first portion 102a and the second portion 102b) and the supercritical fluid 104. In this example, a surface of the heat-generating component 106 contacts a surface of the heat-transfer device 101 to facilitate the transfer the heat away from the heat-generating component 106.

The housing comprises a heat-absorption wall (e.g., a sidewall of the second portion 102b) configured to absorb heat from the heat-generating component 106. The housing comprises at least one heat-dissipation wall which may comprise other surfaces of the housing (e.g., any sidewall of the first portion 102a, other portions of the second portion 102b) configured to dissipate heat from the heat-generating component 106. In general, heat may dissipate from any surface of the housing. The first portion 102a and the second portion 102b are oriented parallel to one another and, generally, are of similar shape and size to one another. A space (i.e., the internal cavity 110) between the first portion 102a and the second portion 102b is substantially filled with the supercritical fluid 104. Because the supercritical fluid 104 substantially fills the internal cavity 110, the supercritical fluid 104 simultaneously contacts the heat-absorption wall and the at least one heat-dissipation wall. An outer surface of the heat-absorption wall contacts the heat-generating component 106. An inner surface of the heat-absorption wall contacts a first portion of the supercritical fluid 104 (e.g., in an area immediately adjacent to the heat-generating component 106). An outer surface of the heat-dissipation wall is positioned distal the heat-generating component 106. An inner surface of the at least one heat-dissipation wall contacts a second portion of the supercritical fluid 104. The first portion of the supercritical fluid 104 comprises the fluid in the supercritical state having a first density (i.e., based on a local temperature within a portion of the supercritical fluid adjacent to the heat-generating component 106) and the second portion of the supercritical fluid 104 comprises the fluid in the supercritical state having a second density. In general, heat from the heat-generating component diffuses through the supercritical fluid 104 according to a temperature gradient between the highest temperatures near the heat-generating component 106 and lower temperatures near periphery of the internal cavity 110. Buoyant forces resulting from differences in temperature and, therefore, differences in density (e.g., a difference between the first density and the second density) cause the supercritical fluid 104 to circulate within the cavity. The supercritical fluid 104 is configured to circulate in a closed loop within the internal cavity 110 based on changes in density of one or more portions of the supercritical fluid 104. Though the density of the supercritical fluid 104 is not homogeneous in density (i.e., different portions of the supercritical state can have a different density), the phase of the matter of the supercritical fluid 104 is homogeneous (i.e., substantially all of the fluid remains in the supercritical state and not liquid, solid, or gaseous states). The supercritical fluid 104 absorbs heat, while the fluid is in the supercritical state, from the heat-generating component. In addition, the supercritical fluid dissipates heat (from the heat-generating component 106) while the fluid is in the supercritical state. The fluid remains in the supercritical state between absorption and dissipation of heat. In this single-phase system (i.e., the heat-transfer device 101), the supercritical fluid 104 circulates vigorously due to high density variation. In two-phase systems, the working fluid separates into liquid and vapor, which causes liquid separation or drop out (when gravity is present) and can negatively impact performance of the system.

The supercritical fluid 104 is configured to circulate in a closed loop within the internal cavity 110 based on changes in density of one or more portions of the supercritical fluid 104. Heat is received by the heat-absorption wall from the heat generating component 106. The heat is transferred from the outer surface (through the thickness of the wall) to the inner surface of the heat-absorption wall, which contacts the supercritical fluid 104. The supercritical fluid 104 is heated by the heat-generating component 106 based on the contact between the supercritical fluid 104 and the heat-absorption wall. The density of the supercritical fluid 104 decreases based on the increase in temperature and, therefore, moves away from the heat generating component 106 and moves toward the periphery of the internal cavity 110 based on being heated. The supercritical fluid 104 is cooled by the at least one heat-dissipation wall based on contact between the supercritical fluid 104 and the at least one heat-dissipation wall. Heat from the supercritical fluid 104 is transferred to the at least one heat-dissipation wall. Heat is received by the at least one heat-dissipation wall from the supercritical fluid 104; the heat is transferred from the inner surface (through the thickness of the wall) to the outer surface of the at least one heat-dissipation wall, where the heat is dissipated (e.g., in air). As the heat is transferred from the supercritical fluid 104 to the at least one heat-dissipation wall, the supercritical fluid 104 cools. As it cools, the supercritical fluid 104 returns to a region of the internal cavity 110 nearby the heat generating component 106 where the cycle may repeat. For example, FIG. 2B illustrates that the supercritical fluid 104 may circulate in at least two relatively planar loops: one on each side of heat generating component 106 within the internal cavity 110 (based on being cyclically heated by the heat-generating component 106 and cooling at a periphery of the internal cavity 110). As another example, the supercritical fluid 104 moves from the area near the heat-generating component 106 to an area near the periphery of the internal cavity 110, and then returns to the area near the heat-generating component 106; thus, completing the loop. A portion of the supercritical fluid 104 within near the heat-generating component 106 has a different density than a portion of the supercritical fluid 104 within the area near the periphery of the internal cavity 110. This difference in density, at least in part, drives the circulation (loop) of the supercritical fluid 104 within the internal cavity 110. It is noted that, within embodiments of the present disclosure, supercritical fluid may circulate in a manner as illustrated by FIG. 2B or may follow a different circulation pattern. In general, the supercritical fluid circulates between hot spots and/or cool spots within the internal cavity based on changes in density caused by the supercritical fluid absorbing and/or releasing heat.

Advantageously, the heat-transfer device 101 is passive device and, therefore, does not receive electrical power to move the supercritical fluid 104 for cooling the heat-generating component 106 (e.g., no active, power-consuming pump). Instead, the supercritical fluid 104 circulates within the internal cavity 110 based on a density gradient within the supercritical fluid 104. In addition, the supercritical fluid 104 does not change phase to cool the heat-generating component 106. The supercritical fluid 104 is a working fluid that is configured to transfer heat away from the heat-generating component 106 while remaining in the supercritical state. In other words, the supercritical fluid 104 does not undergo a phase change from the supercritical state during the transfer of heat away from the heat-generating component 106 (i.e., no evaporation, no condensation, no freezing, no melting, no sublimation, and no deposition). Moreover, the heat-transfer device 101 excludes any wick and therefore avoids the aforementioned challenges associated with wicks (e.g., wick dry-out, wick-related power limitations, wick-related size limitations, and the like).

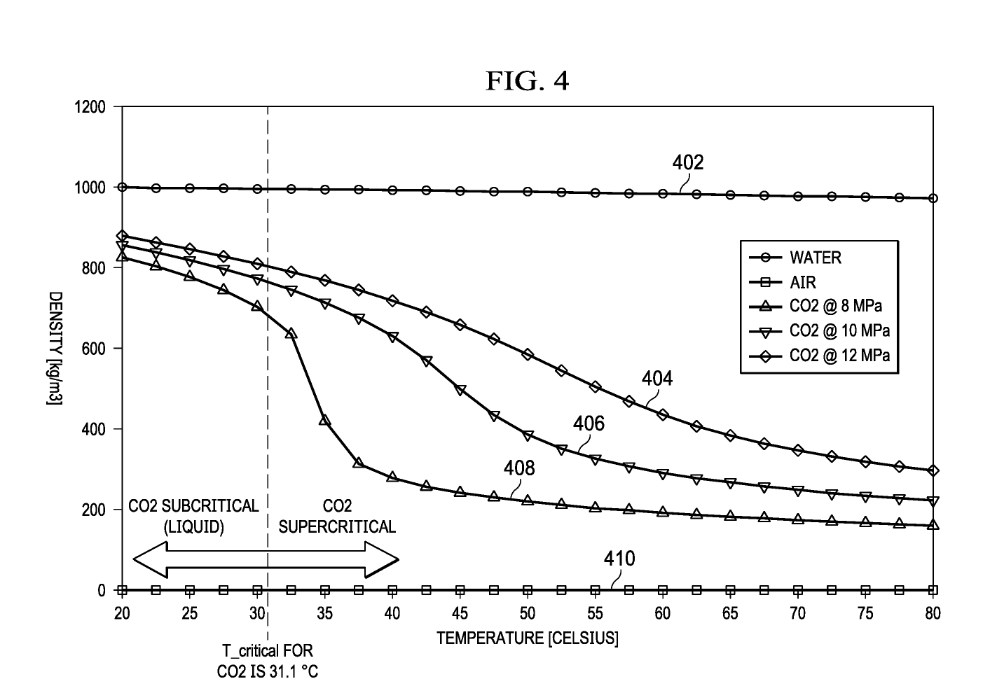

FIG. 3B illustrates an example of the heat-transfer device 101 when the fluid 104 is not in a supercritical state (e.g., subcritical state). The fluid 104 (now in the liquid state) may not completely fill the internal cavity 110 and a space 120 exists above the fluid 104. As is discussed further below (with respect to FIG. 4), many different fluids can be used in the heat-transfer devices of the present disclosure. Depending on the specific fluid used, the fluid can be in a subcritical state (e.g., liquid state) at some temperatures. For example, nitrous oxide (N₂O) has a critical temperature of about 36.4° C.; carbon dioxide (CO₂) has a critical temperature of about 31.1° C.; xenon has a critical temperature of about 16.6° C. At about 20° C., neither N₂O nor CO₂ would in a supercritical state and, instead, would be in the subcritical state. Similarly, at about 5° C., xenon would not be in a supercritical state and, instead, would be in the subcritical state.

This supercritical state of the fluid 104 (as illustrated in FIG. 3B) may be purposely caused (e.g., during manufacture of the heat-transfer device 101) or may occur after the heat-transfer device 101 is manufactured. For example, in some cases, the heat-transfer device 101 is manufactured using a manufacturing process in which the fluid 104 is placed into the cavity in the subcritical state. When the heat-transfer device 101 (and the fluid 104) warms to a temperature above the critical temperature of the fluid 104 (i.e., the fluid 104 becomes supercritical), the supercritical fluid expands to fill the internal cavity 110 (e.g., as is illustrated in FIG. 3A).

The fluid 104 may cycle back and forth between the supercritical state (e.g., as is illustrated in FIG. 3A) and the subcritical state (e.g., as is illustrated in FIG. 3B) based on the ambient temperature in which the heat-transfer device 101 is located. The heat-transfer device 101 does not require a transition form to supercritical state to the subcritical state to transfer heat away from the heat-generating component 106. In some examples, the heat-generating component 106 has a normal operating temperature range of about 45-100° C. and maximum safe temperatures of up to 200° C. In such examples, some fluids (e.g., nitrous oxide (N₂O), carbon dioxide (CO₂), xenon, krypton, or any fluid that remains supercritical below the normal operating temperature range) remain supercritical while cooling the heat-generating component 106 from a temperature at or above its maximum safe temperature down to a temperature within its normal operating temperature range.

Each heat-transfer device of the present disclosure is manufactured, e.g., using a manufacturing process. The manufacturing process can produce relatively small variations in the manufacture of each heat-transfer device (e.g., within manufacturing tolerances). Some variations, if within an acceptable range, do not prevent the heat-transfer device from properly functioning (i.e., the heat-transfer device will efficiently and effectively absorb heat from and transfer heat away from a heat-generating component). As an example, in the manufacturing process, the internal cavity (e.g., internal cavity 110) of each heat-transfer device is substantially filling with a fluid (e.g., a supercritical fluid, a subcritical fluid). Such variations in the manufacturing process may result in each device having a slightly different fraction of the internal cavity filled with the supercritical fluid. For example, the manufacturing process can produce one device having an internal cavity that is 100% filled with the fluid and another device having an internal cavity that is 95% filled with the fluid. In some examples, the fraction of the internal cavity filled with the supercritical fluid ranges from 100% to about 98%. In other examples, the fraction ranges from 100% to about 95%. In still other example, the fraction ranges from about 99% to about 93%.

It is noted that while the heat-transfer device 101 of FIGS. 1, 2, and 3, includes a housing comprising the first portion 102a and the second portion 102b, which are sealed together to contain the supercritical fluid 104. Embodiments of the present disclosure are not limited to such an implementation. In some embodiments, the first portion 102a and the second portion 102b are continuous with one another. In other embodiments, the housing includes a larger number of portions (e.g., 3 portions, 4 portions, etc.). Also, the heat-transfer device 101 of FIGS. 1, 2, and 3, directly contacts the heat-generating component. In some embodiments, one or more intermediate materials lie between the heat-transfer device 101 and the heat-generating component 106 (e.g., to facilitate physically and/or thermally coupling the heat-transfer device 101 and the heat-generating component 106 to one another). Moreover, the teachings of the present disclosure are equally applicable to heat-transfer devices of various sizes (i.e., dimensions D1, D2, and D3), shapes, orientations while deployed (vertical, horizontal, diagonal), and/or relative sizes (e.g., between the heat-transfer device 101 and the heat-generating component 106).

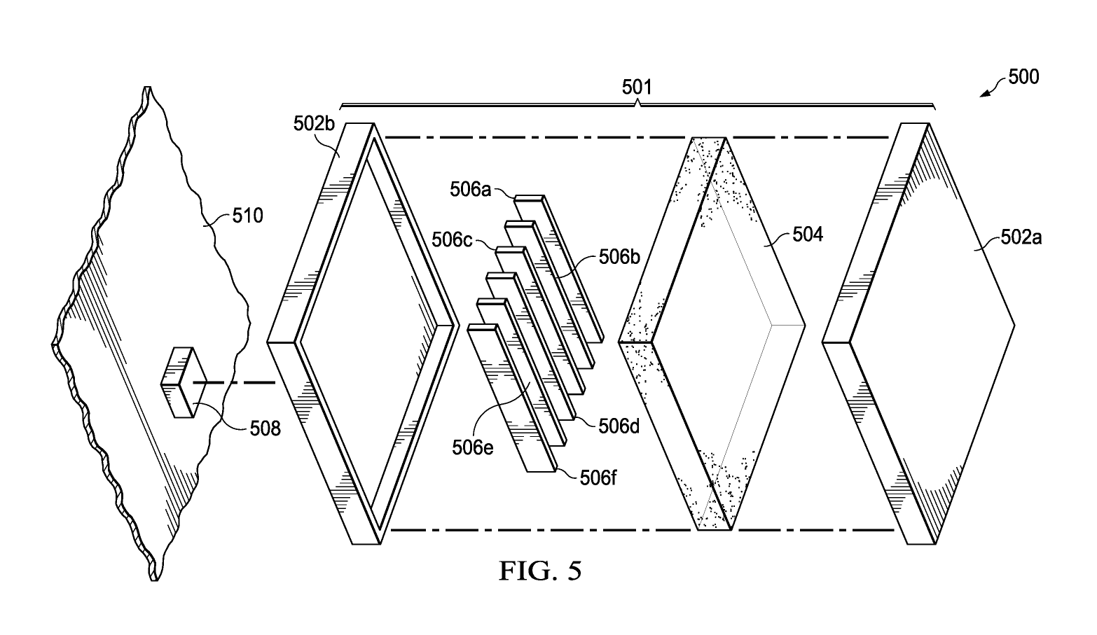

The high temperature and/or pressure required to maintain some fluids in a supercritical state creates a technical challenge of maintaining the structural integrity of the housing. In some examples, the internal cavity 110 may include one or more members to provide structural support to the housing and/or to control the circulation of the supercritical fluid 104 within the internal cavity 110. The internal cavity 110 may comprise a plurality of structural members coupling the at least two walls. Tension members that support the walls of the chamber, e.g., to prevent the extreme pressures from rupturing and/or deforming the housing. The internal cavity 110 may comprise a plurality of fins within the internal cavity to direct flow of the supercritical fluid, wherein each of the plurality of fins extends from one of the least two walls. Examples of internal members are discussed with respect to, e.g., FIGS. 5-15.

In embodiments of the present disclosure, a supercritical fluid absorbs and dissipates heat while remaining in the supercritical state. Some devices are designed to operate in temperatures ranging from about −40° C. to about 120° C. In addition, some devices are designed to maintain ergonomic limits on temperature (e.g., safe for human handling) that can be about 32° C. or 60° C. Thus, the supercritical fluid remains in the supercritical state at least while cooling in the range of about 35° C. to 40° C. (among other temperature ranges). In some embodiments, the critical temperature of the fluid (i.e., comprised in the supercritical fluid) lies below the temperature range in which it provides cooling. This ensures that the supercritical fluid remains in the supercritical state while providing the cooling. For some fluids, the density of the fluid in the supercritical state drops steeply relative to temperature when near the critical temperature (i.e., there exists a more pronounced buoyancy change near the critical temperature). This sharp drop in density can be used to drive circulation of the supercritical fluid based on relatively small changes in temperature. Thus, some embodiments of the present disclosure utilize a fluid with a critical temperature within several degrees of the temperature range in which it provides cooling (to take advantage of the pronounced buoyancy changes). Any one of a number of different fluids may be used in embodiments of the present disclosure (i.e., provided that they each can remain supercritical in the temperature range in which it provides cooling, e.g., about 35° C.-about 120° C.). Some embodiments of the present disclosure utilize a fluid selected from the group consisting of: nitrous oxide (N₂O) (critical temp. 36.4° C., critical press. 7.24 MPa)), carbon dioxide (CO₂) (critical temp. 31.1° C., critical press. 7.39 MPa), xenon (critical temp. 16.6° C., critical press. 5.84 MPa), krypton (critical temp. −63.8° C., critical press. 5.5 MPa), and the like.

FIG. 4 is a graph of density relative to temperature for various liquids, each at a specific pressure. The density is represented along the vertical axis of the graph and is measured in kilograms per cubic meter (kg/m³). The graph illustrates a density range of zero kg/m³ to 1200 kg/m³. The temperature is represented along the horizontal axis of the graph and is measured in degrees Celsius (° C.). The graph illustrates a temperature range of zero ° C. to 80° C. The plot 402 corresponds to water at atmospheric pressure (i.e., 1 ATM or about 0.1 megaascal (MPa)). The plot 404 corresponds to carbon dioxide (CO₂) at 12 MPa. The plot 406 corresponds to CO₂ at 10 MPa. The plot 408 corresponds to CO₂ at 8 MPa. The plot 410 corresponds to air at atmospheric pressure. The critical temperature of CO₂ is about 31.1° C. The critical pressure of CO₂ is about 7.39 MPa. Thus, each of the plots 404, 406, and 408 correspond to CO₂ above the critical temperature of CO₂. In general, above the critical temperature, the CO₂ of the plots 404, 406, and 408 is in the supercritical state. Below the critical temperature, the CO₂ may be in a subcritical state. In some cases, the CO₂ (though above its critical pressure), may fall below the critical temperature. Advantageously, the embodiments of the present disclosure do not require a phase change to provide cooling. Some embodiments of the present disclosure utilize a fluid selected from the group consisting of: nitrous oxide (N₂O), carbon dioxide (CO₂), xenon, krypton, and the like, each of has buoyancy effects that help facilitate passive cooling. CO₂ is described below as a non-limiting, illustrative example.

Carbon dioxide (CO₂) provides dramatic buoyancy effects that help facilitate passive cooling in embodiments of the present disclosure. As an example, when CO₂ is utilized at a working pressure of 8.0 MPa (e.g., corresponding to plot 408), the density of supercritical CO₂ is (slightly) more than half the density of liquid water at atmospheric pressure (which is −500 kg/m³). In addition, the thermal mass (or heat carrying capacity) of supercritical CO₂ varies between about 2 and 8 kJ/kg*K, which is comparable to that of water (4.2 kJ/kg*K). However, the compressibility of the supercritical CO₂ gives it a buoyant potential (e.g., a density gradient with temperature) that is 50 times that of liquid water. Supercritical CO₂ also has a kinetic viscosity that is half that of liquid water. Consequently, a Grashof number (i.e., ratio of buoyant forces to viscous forces) for supercritical CO₂ in a temperature range of about 40° C. to 50° C. is about 100 times greater than the Grashof number for water (at atmospheric pressure) in the same temperature range. The Grashof number is a dimensionless number that describes a particular flow in a particular geometry (e.g., within a particular device), driven by a particular temperature difference. The Grashof number is dependent on operating temperatures and on flow/device dimensions, as illustrated by Equation 1 below.

$$Grashof number = \frac{ℊ * ( \frac{delta density}{density} ) * {L}^{3}}{{( kinematic viscosity )}^{2}} \qquad Equation 1$$

In equation 1, g is acceleration due to gravity (on Earth). For a given temperature delta (50° C. to 40° C.) and the known densities and viscosities for CO₂ (at 8 MPa) and water liquid (at 1 ATM) described above, the Grashof number for CO2 is 100× that of water for any given dimension L (of Equation 1). The buoyant forces help circulate the supercritical CO2 in the heat-transfer devices of the present disclosure. In contrast, the viscosity forces tend to oppose the free movement of the fluid. Advantageously, for supercritical CO₂, the buoyant forces far outweigh the viscosity forces (at a ratio that also far exceeds that of water).

As illustrated in the graph, the density of high pressure CO₂ (e.g., above the critical pressure of CO₂) (whether subcritical or super critical) drops relatively steeply based on relatively small changes in temperature (e.g., relative to water and air). The drop for high pressure CO₂ is more pronounced near the critical temperature. This sharp drop in density is used in some embodiments of the present disclosure to drive circulation of high pressure CO₂ based on relatively small changes in temperature. CO₂ at each of 12 MPa, 10 MPa, and 8 MPa (i.e., plots 404, 406, and 408, respectively) provides dramatically increased buoyancy effects relative to air and water (i.e., plots 402 and 410, respectively). Each of the plots 404, 406, and 408 drop more sharply than the plots 402 and 410. The plot 404 (CO₂ at 12 MPa) has a slope that varies from about −16.0 (kg/m³)/° C. (at the steepest) to about −4.0 (at the shallowest). The plot 406 (CO₂ at 10 MPa) has a slope that varies from about −28.4 (kg/m³)/° C. (at the steepest) to about −2.3 (at the shallowest). The plot 408 (CO₂ at 8 MPa) has a slope that varies from about −86.3 (kg/m³)/° C. (at the steepest) to about −1.2 (at the shallowest). The plot 402 has a slope that varies from about −0.22 (kg/m³)/° C. (at the shallowest) to about −0.61 (at the steepest). The plot 410 has a slope that varies from about −4.0*10⁻³ to about −2.8*10⁻³. In many cases, the slope (and corresponding buoyancy effects) of the CO₂ is several orders of magnitude greater than that of air or water.

Any fluid may be used in embodiments of the present disclosure (i.e., provided that it can remain supercritical in a temperature range, e.g., about 35° C.-about 80° C. and/or has a slope having a magnitude (absolute value) of about 1 (kg/m³)/° C. or more (e.g., −1 or less), and does not have an adverse reaction with the walls of the housing/internal cavity). In some examples, the fluid used in the heat-transfer devices of the present disclosure have a slope with a magnitude of at least 10 (kg/m³)/° C. (e.g., −10 or less). For example, some embodiments of the present disclosure utilize CO₂ at about 8 MPa to provide cooling within a temperature range comprising about 32° C. to about 40° C., where the slope of the plot 408 ranges from about −86.6 (kg/m³)/° C. to about −14.1 (kg/m³)/° C. (e.g., to take advantage of the pronounced buoyancy change). Some embodiments of the present disclosure utilize CO₂ at about 10 MPa to provide cooling within a temperature range comprising about 35° C. to about 53° C., where the slope of the plot 406 ranges from about −28.4 to about −12.5. Some embodiments of the present disclosure utilize CO₂ at about 12 MPa to provide cooling within a temperature range comprising about 40° C. to about 63° C., where the slope of the plot 404 ranges from about −28.4 (kg/m³)/° C. to about −10.3 (kg/m³)/° C. It is noted that embodiments of the present disclosure are not limited to using carbon dioxide as the working fluid (for passive heat dissipation).

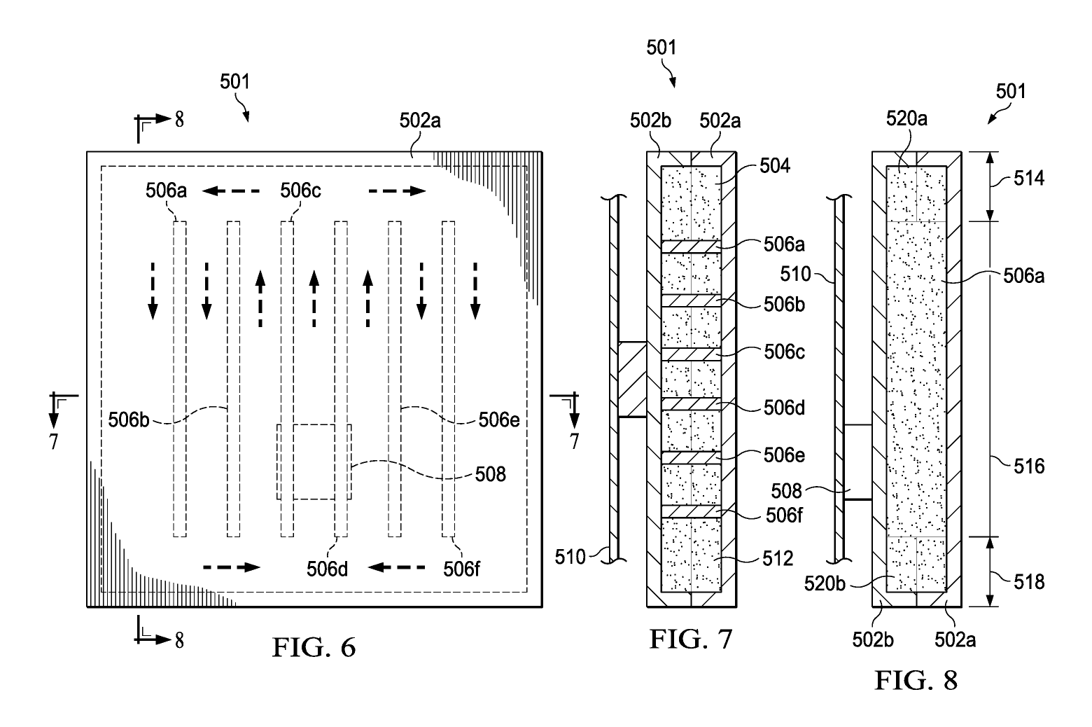

FIGS. 5, 6, 7, and 8 illustrate various views of a system 500 comprising a heat-transfer device 501 for cooling a heat-generating component 508, which is coupled to a circuit board 510, according to some embodiments of the present disclosure. FIG. 5 is a partially exploded diagram of the system 500 in which the heat-transfer device 501 comprises a plurality of fins (i.e., fins 506a, 506b, 506c, 506d, 506e, and 5060 to direct flow of a supercritical fluid 504. FIG. 6 is a plan view of the system 500. FIG. 7 is a sectional view of the system 500 from a viewpoint as generally indicated by the section lines labeled “7” in FIG. 6. FIG. 8 is a sectional view of the system 500 from a viewpoint as generally indicated by the section lines labeled “8” in FIG. 6. Collectively, the plurality of fins 506a, 506b, 506c, 506d, 506e, and 506f are referred to as the “fins 506” and/or the “fins 506a-f”.

The heat-transfer device 501 comprises a housing and the supercritical fluid 504. The housing comprises a first portion 502a and a second portion 502b. The housing forms an internal cavity 512, which encloses the supercritical fluid 504. The supercritical fluid 504 substantially fills the internal cavity 512 and contacts surfaces of the internal cavity 512. The first portion 502a and the second portion 502b are attached by an attachment mechanism, which seals closed the internal cavity 512. The heat-transfer device 501 uses the supercritical fluid 504 to cool the heat-generating component 508, which in this case is mounted on and electrically coupled to the circuit board 510. The housing comprises a heat-absorption wall (e.g., a sidewall of the second portion 502b) configured to absorb heat from the heat-generating component 508 and a heat-dissipation wall (e.g., any sidewall of the first portion 502a, areas of the second portion 502a not in contact with the heat-generating component 508) configured to dissipate heat from the heat-generating component 508. In general, some components of the heat-transfer device 501 (e.g., the housing, the internal cavity, the supercritical fluid) are similar in structure operation to corresponding components described with respect to the heat-transfer device 101 of FIGS. 1, 2, and 3. The description of such components is not repeated here only for the sake of brevity of the specification. A difference between the heat-transfer device 101 (of FIGS. 1, 2, and 3) and the heat-transfer device 501 (of FIGS. 5, 6, 7, and 8) is that the heat-transfer device 501 comprises fins 506a-f while the heat-transfer device 101 lacks such fins.

The fins 506a-f are configured to control the circulation of the supercritical fluid 405 within the internal cavity 512 of the heat-transfer device 501. FIG. 5 illustrates, among other things, an isometric view of the fins 506a-f. Each of the fins 506a-f is configured to extend from at least one wall of the internal cavity 512. FIG. 6 illustrates, among other things, locations of each the fins 506a-f within the internal cavity 512 of the heat-transfer device 501. The fins 506a-f are generally uniformly spaced within the heat-transfer device 501. For example, a distance between the fins 506a and 506b is approximately the same as a distance between the fins 506b and 506c; similarly, the distance between the fins 506b and 506c is approximately the same as a distance between the fins 506d and 506d, etc. The fins 506a-f span an area beyond the extent of the heat-generating component 508. This configuration of the fins 506a-f enables the fins 506a-f to direct circulation of the supercritical fluid 504 in a closed loop within the internal cavity 512. For example, the fins 506a-f direct the flow of the supercritical fluid 504 as is heated and, as a result, moves upward and outward (e.g., away from the area of the heat-absorption wall corresponding to the heat-generating component 508).

FIGS. 7 and 8 illustrate the heat-transfer device 501 assembled and, e.g., cooling the heat-generating component 508. When the heat-transfer device 501 is assembled, each of the fins 506a-f is attached to and extends between the first portion 502a and the second portion 502b. When the fins 506a-f are attached, each forms openings between the end of the fin and an interior surface of the housing. For example, fin 506a forms openings 520a and 520b having dimensions labeled 514 and 518 respectively in the FIG. 8. The fin 506a has a length labeled 516 in FIG. 8. Collectively, the openings form a channel (or manifold) through which the supercritical fluid 504 can flow laterally within the internal cavity 110. In addition, gaps between adjacent pairs of the fins 506a-f and between the fins 506a-f and the housing form channels through which the supercritical fluid 504 can flow vertically within the internal cavity 110.

The supercritical fluid 504 is configured to circulate in a closed loop within the internal cavity 512 based on changes in density of one or more portions of the supercritical fluid 504 (e.g., as generally indicated by arrows in FIG. 6 shown overlaid on the heat-transfer device 501). The supercritical fluid 504 is transported by buoyant forces that result from a density gradient in the supercritical fluid 504. The supercritical fluid 504 is not through capillary forces in a wick and, therefore, does is not subject to wick related issues such as wick dry-out. In addition, the fins 506a-f guide the flow of the supercritical fluid 504. The supercritical fluid 504 circulates within the internal cavity 512 and cools the heat-generating component 508 by absorbing and dissipating its heat (i.e., while remaining in the supercritical state). Heat is received from the heat-generating component 508 by the heat-absorption wall, which transfers the heat to the supercritical fluid 504. The supercritical fluid 504 is heated by the heat-generating component 508 based on contact between the supercritical fluid 504 and the heat-absorption wall, causing the supercritical fluid 504 to float upwardly through the gaps between some of the fins 506a-f toward a (vertically) higher region of the internal cavity 110. The supercritical fluid 504 is cooled by at least one heat-dissipation wall (e.g., portions of walls not in direct contact with the heat-generating component 508) based on contact between the supercritical fluid 504 and the at least one heat-dissipation wall. Heat from the supercritical fluid 504 is transferred to the at least one heat-dissipation wall. Heat received from the supercritical fluid 504 by the at least one heat-dissipation wall is dissipated in air. As the heat is transferred from the supercritical fluid 504 to the at least one heat-dissipation wall, the supercritical fluid 104 cools. As it cools, the density of the supercritical fluid 104 increases and, therefore, it tends to sink through the gaps between some of the fins 506a-f toward a (vertically) lower region of the internal cavity 110. The upward motion of hotter (less dense) portions of the supercritical fluid 504 adjacent the heat-generating component 508 causes cooler (denser) portions of the supercritical fluid 504 to move laterally away from the heat-generating component 508 (e.g., through the channels between the ends of the fins 506a-f and the housing) before falling through the gaps between some of the fins 506a-f toward the heat-absorption wall. In addition, the upward motion of hotter (less dense) portions of the supercritical fluid 504 adjacent the heat-generating component 508 draws the cooler (denser) portions of the supercritical fluid 504 toward the heat-generating component 508, where the loop may repeat and continue cooling the heat-generating component 508.

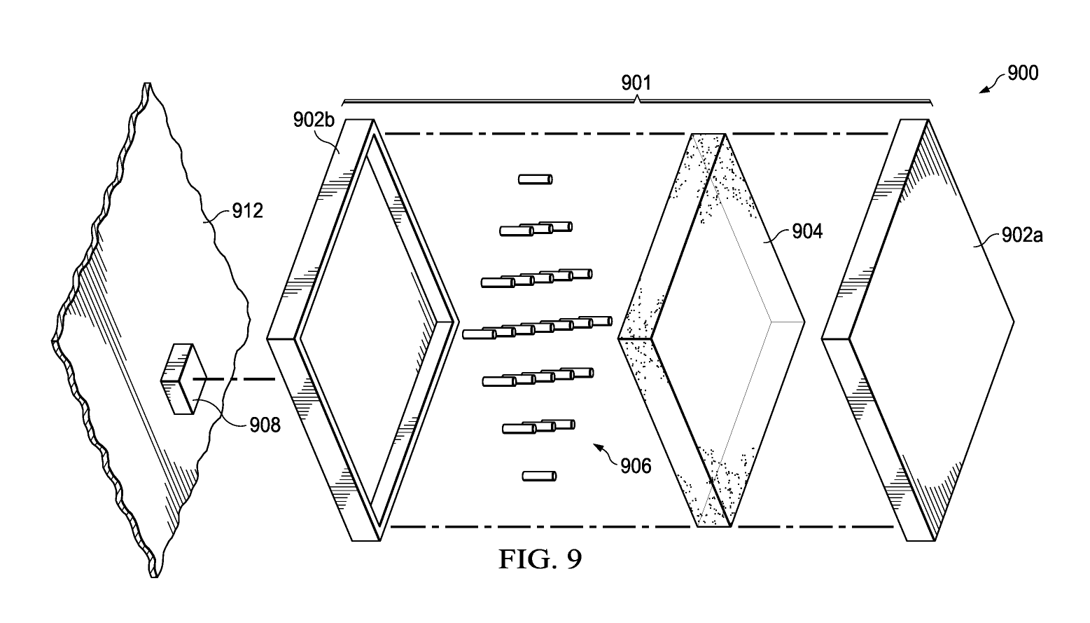

Utilizing a supercritical fluid for cooling can present some technical challenges including, for example, extreme temperatures and pressures which must be maintained to keep the fluid in the supercritical state. To address this challenge (and other challenges), some embodiments of heat-transfer devices (according to the present disclosure) include structural members to maintain the structural integrity of the housing; FIGS. 9, 10, and 11 illustrate some examples.

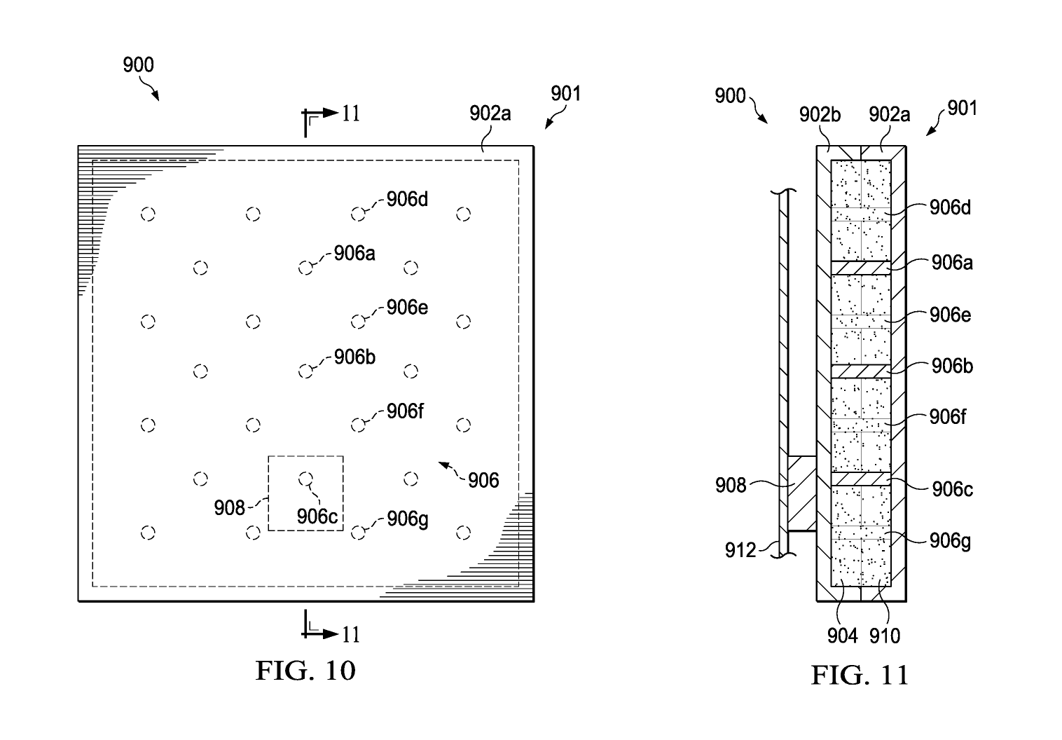

FIGS. 9, 10, and 11 illustrate various views of a system 900 comprising a heat-transfer device 901 for cooling a heat-generating component 908, which is coupled to a circuit board 912, according to some embodiments of the present disclosure. FIG. 9 is a partially exploded diagram of the system 900 in which the heat-transfer device 901 comprises a plurality of structural members 906 to support to a housing of the heat-transfer device 901. FIG. 10 is a plan view of the system 900. FIG. 11 is a sectional view of the system 900 from a viewpoint as generally indicated by the section lines labeled “11” in FIG. 10.

The heat-transfer device 901 comprises a housing and a supercritical fluid 904. The housing comprises a first portion 902a and a second portion 902b. The housing forms an internal cavity 910, which encloses the supercritical fluid 904. The supercritical fluid 904 substantially fills the internal cavity 910 and contacts surfaces of the internal cavity 910. The first portion 902a and the second portion 902b are attached to one another by an attachment mechanism, which seals closed the internal cavity 910. The heat-transfer device 901 uses the supercritical fluid 904 to cool the heat-generating component 908, which in this case is mounted on and electrically coupled to the circuit board 912. The housing comprises a heat-absorption wall (e.g., a sidewall of the second portion 902b) configured to absorb heat from the heat-generating component 908 and one or more heat-dissipation walls (e.g., any sidewall of the first portion 902a and/or areas of the second portion 902b not in direct contact with the heat-generating component 908) configured to dissipate heat from the heat-generating component 908. In general, some components of the heat-transfer device 901 (e.g., the housing, the supercritical fluid) are similar in structure and operation to corresponding components described with respect to the heat-transfer device 101 of FIGS. 1, 2, and 3. The description of such components is not repeated here only for the sake of brevity of the specification. A difference between the heat-transfer device 101 (of FIGS. 1, 2, and 3) and the heat-transfer device 901 (of FIGS. 9, 10, and 11) is that the heat-transfer device 901 comprises structural members 906 while the heat-transfer device 101 lacks such structural members.

The structural members 906 are located within the internal cavity 910 and are configured to provide structural support to the housing. Each of the structural members 906 is cylindrical in shape and extends between opposing internal surfaces of the internal cavity 512 (i.e., in this case, span between internal surfaces of the first portion 902a and the second portion 902b). FIG. 10 illustrates, among other things, locations of each the structural members 906 within the internal cavity 910 of the heat-transfer device 901. The structural members 906 are placed in a grid pattern within the heat-transfer device 501. The regular spacing provides relatively uniform support across the expanse of the housing to resist the extreme pressures (i.e., needed to maintain the fluid in a supercritical state). The sectional view of FIG. 11 cuts through several of the structural members 906 (i.e., structural members 906a, 906b, and 906c) and illustrates the heat-transfer device 901 assembled and, e.g., cooling the heat-generating component 908. When the heat-transfer device 501 is assembled, each of the structural members 906 is attached to and extends between the heat-absorption wall and the heat-dissipation wall. The structural members 906 exert tensile resistance when the internal cavity 910 is pressurized (e.g., to a positive pressure of 8 MPa or more). The structural members 906 are tension members that support the walls of the internal cavity, e.g., to reduce the likelihood of the pressure causing deformation and/or rupture of the housing.

The supercritical fluid 904 easily flows around the structural members 906 due, at least in part, to their smooth, cylindrical shape. The structural members 906 may not significantly disturb the circulation of the supercritical fluid 904. The supercritical fluid 904 is configured to circulate in a closed loop within the internal cavity 910 based on changes in density of one or more portions of the supercritical fluid 904. The circulation of the supercritical fluid 904 within the heat-transfer device 901 is similar to the circulation of the supercritical fluid 104 within the heat-transfer device 901 as described with respect to FIGS. 1, 2, and 3 and, e.g., as generally indicated by arrows in FIGS. 2B and/or 3A within the supercritical fluid 104.

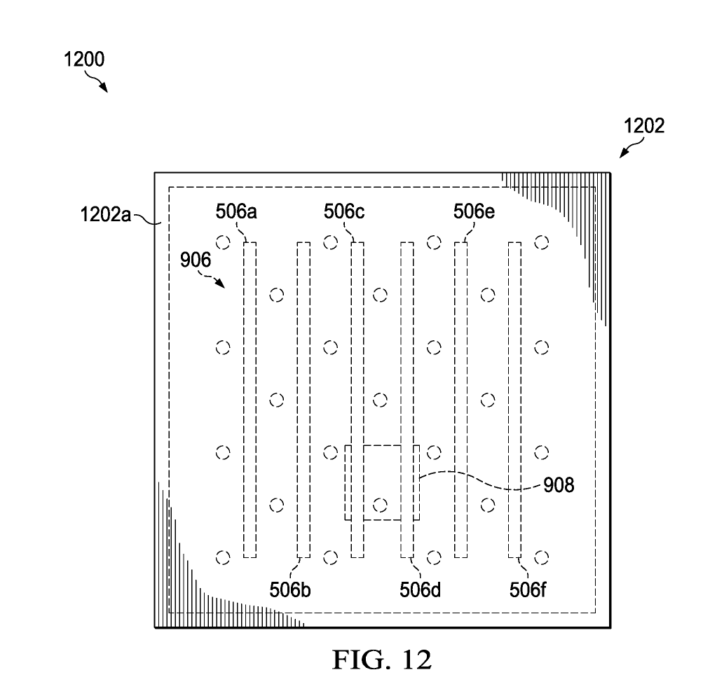

In the above examples (e.g., the heat-transfer device 501 of FIGS. 5, 6, 7 and 8 and the heat-transfer device 901 of FIGS. 9, 10, and 11), a heat-transfer device includes members to provide structural support to the housing or members to control circulation of the supercritical fluid within an internal cavity. Embodiments of the present disclosure are not limited to such examples. Indeed, a single embodiment of the present disclosure can include combinations of features disclosed herein. For example, some embodiments combine members to provide structural support to the housing and members to control circulation of the supercritical fluid within an internal cavity; FIG. 12 illustrates an example.

FIG. 12 is a plan view of a system 1200 comprising a heat-transfer device 1202 for cooling the heat-generating component 908, according to some embodiments of the present disclosure. The heat-transfer device 1202 comprises a supercritical fluid (enclosed within an internal cavity), fins 506, and structural members 906. In general, some components of the heat-transfer device 1202 (e.g., a housing, the supercritical fluid, the internal cavity) are similar in structure and operation to corresponding components described with respect to the heat-transfer device 101 of FIGS. 1, 2, and 3. The description of these components is not repeated here only for the sake of brevity. The fins 506 are described with respect to the heat-transfer device 501 of FIGS. 5, 6, 7 and 8. The structural members 906 are described with respect to the heat-transfer device 901 of FIGS. 9, 10, and 11. The description of these members (i.e., the fins and structural members) is not repeated here only for the sake of brevity. In general, the fins 506 provide structural support to the housing and the structural members 906 control circulation of the supercritical fluid within an internal cavity.

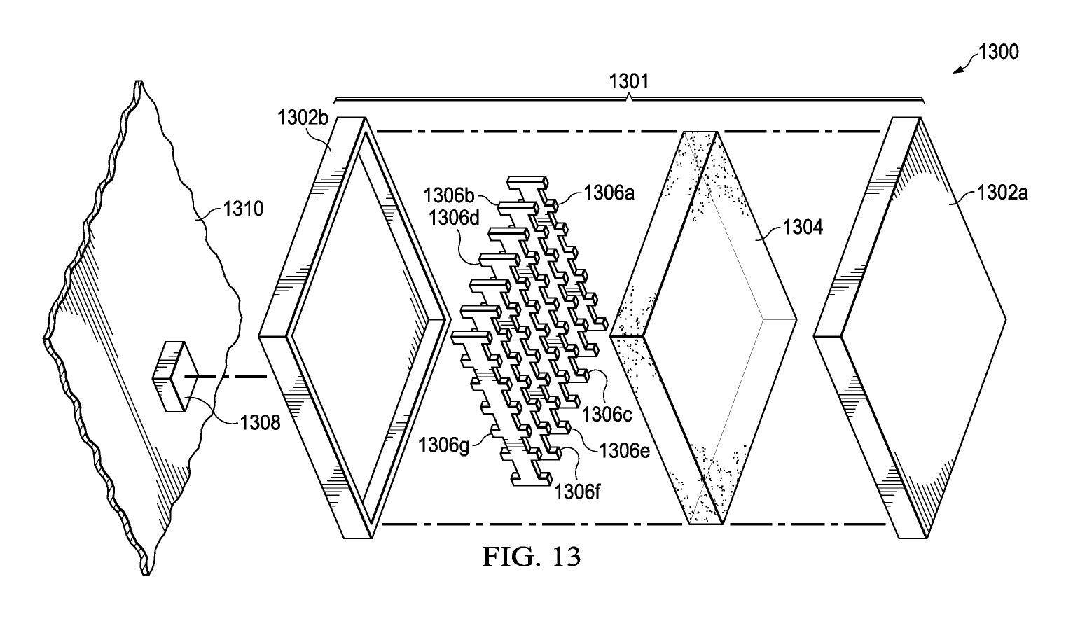

In the heat-transfer device 1202 of FIG. 12, separate members provide structural support and control circulation. In other embodiments of a heat-transfer device, a single, continuous member can simultaneously provide structural support and control circulation of the supercritical fluid within an internal cavity. Relative to including separated fins and structural members, such single members may consume less space within the internal cavity, utilize fewer parts, and/or simplify manufacturing of the heat-transfer device; FIGS. 13, 14, and 15 illustrate an example.

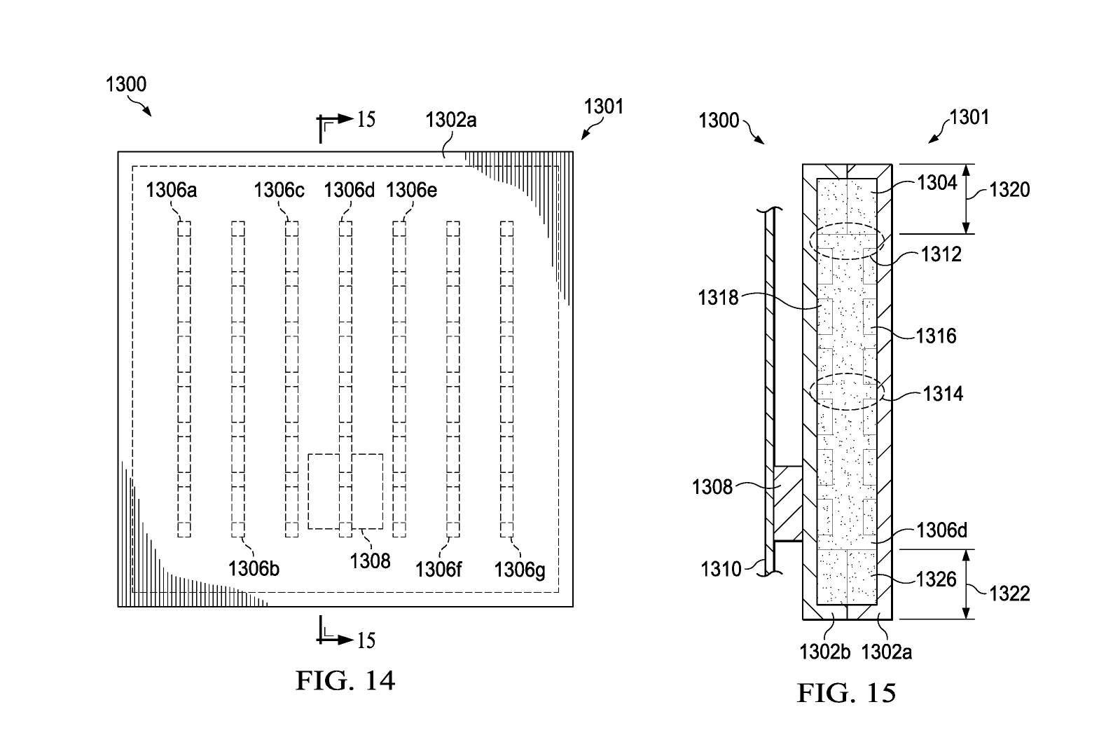

FIGS. 13, 14, and 15 illustrate various views of a system 1300 comprising a heat-transfer device 1301 for cooling a heat-generating component 1308, which is coupled to a circuit board 1310, according to some embodiments of the present disclosure. FIG. 13 is a partially exploded diagram of the system 1300 in which the heat-transfer device 1301 comprises a plurality of members (i.e., structural fins 1306a, 1306b, 1306c, 1306d, 1306e, 1306f, and 1306g) to simultaneously direct flow of a supercritical fluid 1304 and provide structural support to a housing of the heat-transfer device 1301. FIG. 14 is a plan view of the system 1300. FIG. 15 is a sectional view of the system 1300 from a viewpoint as generally indicated by the section lines labeled “15” in FIG. 14. Collectively, the plurality of structural fins 1306a, 1306b, 1306c, 1306d, 1306e, 1306f, and 1306g are referred to as the “structural fins 1306.”

The heat-transfer device 1301 comprises a housing and a supercritical fluid 1304. The housing comprises a first portion 1302a and a second portion 1302b. The housing forms an internal cavity 910, which encloses the supercritical fluid 904. The supercritical fluid 1304 substantially fills the internal cavity 1326 and contacts surfaces of the internal cavity 1326. The first portion 1302a and the second portion 1302b are attached to one another by an attachment mechanism, which seals closed the internal cavity 1326. The heat-transfer device 1301 uses the supercritical fluid 1304 to cool the heat-generating component 1308, which in this case is mounted on and electrically coupled to the circuit board 1310. The housing comprises a heat-absorption wall (e.g., a sidewall of the second portion 1302b) configured to absorb heat from the heat-generating component 1308 and one or more heat-dissipation walls (e.g., any sidewall of the first portion 1302a and/or areas of the second portion 1302b not in contact with the heat-generating component 1308) configured to dissipate heat from the heat-generating component 1308. In general, some components of the heat-transfer device 1301 (e.g., the housing, the supercritical fluid, the internal cavity) are similar in structure and operation to corresponding components described with respect to the heat-transfer device 101 of FIGS. 1, 2, and 3. The description of such components is not repeated here only for the sake of brevity of the specification. A difference between the heat-transfer device 101 (of FIGS. 1, 2, and 3) and the heat-transfer device 1301 (of FIGS. 13, 14, and 15) is that the heat-transfer device 1301 comprises structural fins 1306 while the heat-transfer device 101 lacks such structural fins.

Each of the structural fins 1306 is a single member that both provides structural support and controls circulation of the supercritical fluid 1304 within the internal cavity 1326. Advantageously, such single members may consume less space within the internal cavity, utilize fewer parts, and/or simplify manufacturing of the heat-transfer device 1301 (e.g., relative to two or more separate parts). Each of the structural fins 1306 includes at least one structural-support portion and at least one flow-control portion. For example, FIG. 15 illustrates various portions of the structural fin 1306d. The structural fin 1306d comprises structural-support portions (e.g., 1312 and 1314) and at least one flow-control opening (e.g., 1316 and 1318). Each of the structural-support portions span between opposing internal surfaces of the internal cavity 1326 (e.g., in this case, span between internal surfaces of first portion 1302a and the second portion 1302b). Each of the flow-control openings facilitate flow of the supercritical fluid 1304 (e.g., the supercritical fluid 1304 can flow through each of the flow-control openings).

Each of the structural fins 1306 forms openings between the end of the fin and an interior surface of the housing. For example, the structural fin 1306d forms a first opening and a second opening having dimensions labeled 1320 and 1322 respectively in the FIG. 15. Collectively, the openings (created by adjacent structural fins) form a channel through which the supercritical fluid 1304 can flow laterally within the internal cavity 1326. The supercritical fluid 1304 is configured to circulate in a closed loop within the internal cavity 1326 based on changes in density of one or more portions of the supercritical fluid 1304. The circulation of the supercritical fluid 1304 within the heat-transfer device 1301 is similar to the circulation of the supercritical fluid 504 within the heat-transfer device 501 as described with respect to FIGS. 5, 6, 7, and 8 and, e.g., as generally indicated by arrows in FIG. 6 within the supercritical fluid 504.

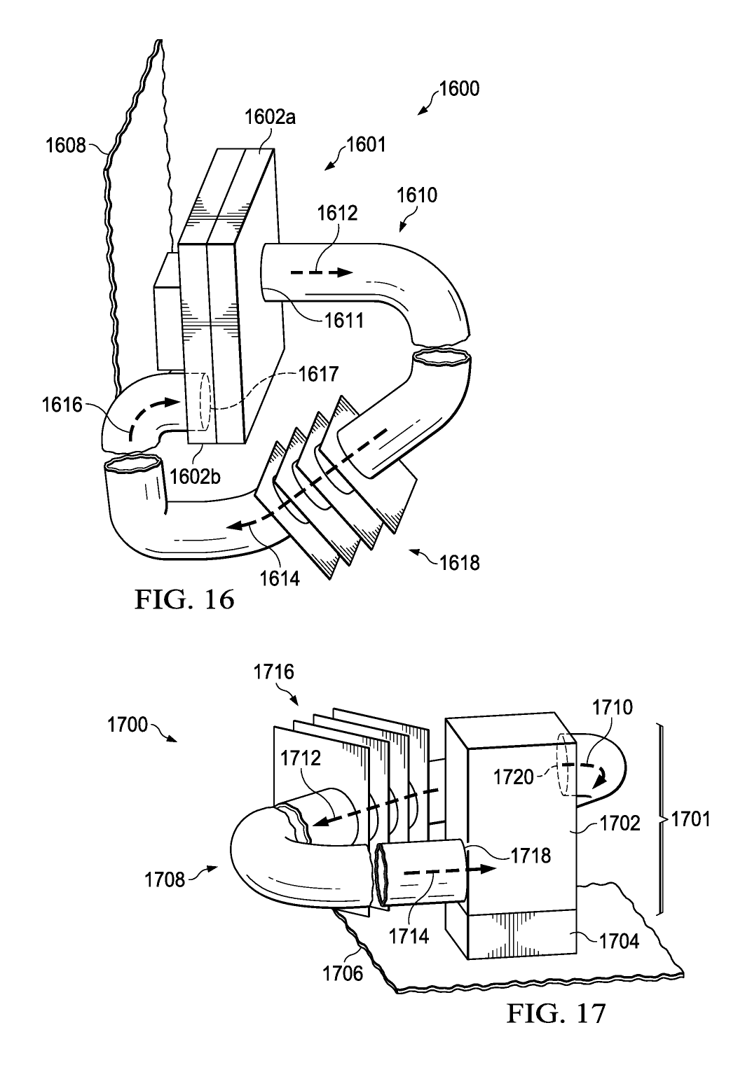

Some embodiments of the present disclosure are two-dimensional heat-transfer devices that spread heat over a relatively large two-dimensional area. Other heat-transfer devices spread heat over a length of one or more linear pipes (referred to herein as “one-dimensional” heat-transfer devices). Such one-dimensional heat-transfer devices dissipate heat across a surface of a length of pipe. FIGS. 16 and 17 (below) illustrate examples of one-dimensional heat-transfer devices.

FIG. 16 is an isometric view of a system 1600 comprising a heat-transfer device 1601 for cooling a heat-generating component 1604, which is coupled to a circuit board 1608, according to some embodiments of the present disclosure. The heat-transfer device 1601 comprises a housing, a pipe 1610, and a supercritical fluid (within the housing and the pipe, not visible). The housing comprises a first portion 1602a and a second portion 1602b. The first portion 102a and the second portion 102b are attached by an attachment mechanism, which seals closed the internal cavity. The housing forms an internal cavity, which encloses a portion of the supercritical fluid. The supercritical fluid comprises a fluid in a supercritical state.

The supercritical fluid substantially fills an internal cavity of the housing and the pipe 1610. The housing also includes a first opening 1611 and a second opening 1617 through which the supercritical fluid can flow to and from the pipe 1610. The pipe 1610 forms a loop between the first opening 1611 and the second opening 1617 in the housing. The full length of the pipe 1610 is not shown (as generally indicated by the breaks in the pipe 1610). However, the pipe 1610 may be of any length (as needed for dissipating heat from the heat-generating component). The second opening 1617 is at a lower elevation than the first opening 1611. Gravity helps to pull the cooling (and increasing density fluid) from the first opening 1611 toward the second opening 1617 based on the difference in elevation. The supercritical fluid remains in the supercritical state while in the pipe 1610. The pipe 1610 transports the supercritical fluid in the loop, which passes through the housing, to cool the supercritical fluid and thereby, dissipate heat from the heat-generating component 1604. The pipe 1610 draws the supercritical fluid (that has been heated by the heat-generating component) from the housing through its length (where it cools) and returns the cooled supercritical fluid to the housing.

The supercritical fluid is configured to circulate in a closed loop within the pipe 1610 based on changes in density of one or more portions of the supercritical fluid. Circulation of the supercritical fluid within the pipe 1610 cools the heat-generating component 1604 by absorbing and dissipating its heat (e.g., while the supercritical fluid remains in the supercritical state). Heat is received from the heat-generating component 1604 by a heat-absorption wall, which transfers the heat to the supercritical fluid. The supercritical fluid is heated by the heat-generating component 1604 based on contact between the supercritical fluid and the heat-absorption wall, causing the supercritical fluid to float upwardly toward the first opening 1611 and into the pipe 1610 (as generally indicate by 1612). The supercritical fluid cools as it travels along the length of the pipe 1610 (as generally indicate by 1614). Heat dissipations fins 1618 further facilitate heat dissipation by increasing the surface area from which the pipe 1610 can dissipate heat. Heat from the supercritical fluid is transferred to walls of the pipe 1610 and the heat dissipations fins 1618. Heat received from the supercritical fluid by the pipe 1610 and the heat dissipations fins 1618 is dissipated in air. As it cools, the density of the supercritical fluid increases and, therefore, it tends to sink through the pipe toward the second opening 1617 (as generally indicate by 1616). In addition, the upward motion of hotter (less dense) portions of the supercritical fluid adjacent the first opening 1611 draws the cooler (denser) portions of the supercritical fluid through the second opening 1617 into the housing, where the loop may repeat and continue cooling the heat-generating component 1604.

In some embodiments, the internal cavity within the heat-transfer device 1601 of FIG. 16 is an open cavity (e.g., similar to the internal cavity 110 of the heat-transfer device 101 in FIGS. 1, 2, and 3). In other embodiments, the internal cavity within the heat-transfer device 1601 includes fins (e.g., similar to the internal cavity 512 of the heat-transfer device 501 in FIGS. 5, 6, 7, and 8). In still other embodiments, the internal cavity within the heat-transfer device 1601 includes structural members (e.g., similar to the internal cavity 910 of the heat-transfer device 901 in FIGS. 9, 10, and 11). In other embodiments, the internal cavity within the heat-transfer device 1601 includes fins and structural members (e.g., similar to the internal cavity of the heat-transfer device 1202 in FIG. 12). In still other embodiments, the internal cavity within the heat-transfer device 1601 includes structural fins (e.g., similar to the internal cavity 1326 of the heat-transfer device 1301 in FIGS. 13, 14, and 5).

Some Figures of the present disclosure illustrate a heat-transfer device in a vertical orientation (e.g., perpendicular to a horizontal plane, parallel to a vertical plane). However, embodiments of the present disclosure may be deployed in any orientation (e.g., vertically, horizontally, diagonally or any orientation). In some examples, a heat-transfer device is oriented at an angle that is oblique to a horizontal plane (e.g., is not horizontally oriented and at least some vertical extent). In some examples, a heat-transfer device is oriented at an angle that is oblique to a vertical plane (e.g., is not vertically oriented and at least some horizontal extent).

FIG. 17 is an isometric view of a system 1700 comprising a heat-transfer device 1701 for cooling a heat-generating component 1704, which is coupled to a circuit board 1706, according to some embodiments of the present disclosure. The heat-transfer device 1701 comprises a housing 1702, a pipe 1708, and a supercritical fluid (within the housing and the pipe, not visible). The housing 1702 forms an internal cavity, which encloses a portion of the supercritical fluid. The supercritical fluid comprises a fluid in a supercritical state.

The supercritical fluid substantially fills an internal cavity of the housing 1702 and the pipe 1708. The housing also includes a first opening 1720 and a second opening 1718 through which the supercritical fluid can flow to and from the pipe 1708. The pipe 1708 forms a loop between the first opening 1720 and the second opening 1718. The full length of the pipe 1708 is not shown (as generally indicated by the breaks in the pipe 1708). However, the pipe 1708 may be of any length (e.g., as needed for dissipating heat from the heat-generating component or traversing around nearby components). The second opening 1718 is at a lower elevation than the first opening 1720. Gravity helps to pull the cooling (and increasing density) supercritical fluid from the first opening 1720 toward the second opening 1718 based on the difference in elevation. The supercritical fluid remains in the supercritical state while in the pipe 1708. The pipe 1708 transports the supercritical fluid in the loop, which passes through the housing 1702, to cool the supercritical fluid and, thereby, dissipate heat from the heat-generating component 1704. The pipe 1708 draws the supercritical fluid (that has been heated by the heat-generating component) from the housing 1702 through its length (where it cools) and returns the cooled supercritical fluid to the housing 1702.

The supercritical fluid is configured to circulate in a closed loop within the pipe 1708 based on changes in density of one or more portions of the supercritical fluid. Circulation of the supercritical fluid within the pipe 1708 cools the heat-generating component 1704 by absorbing and dissipating its heat (e.g., while the supercritical fluid remains in the supercritical state). Heat is received from the heat-generating component 1704 by a heat-absorption wall, which transfers the heat to the supercritical fluid. The supercritical fluid is heated by the heat-generating component 1704 based on contact between the supercritical fluid and the heat-absorption wall, causing the supercritical fluid to float upwardly in the housing. The supercritical fluid moves through the first opening 1720 and into the pipe 1708 (as generally indicate by 1710). The supercritical fluid cools as it travels along the length of the pipe 1708 (as generally indicate by 1712). Heat dissipations fins 1716 further facilitate heat dissipation by increasing the surface area from which the pipe 1708 can dissipate heat. Heat from the supercritical fluid is transferred to walls of the pipe 1708 and the heat dissipations fins 1716. Heat received from the supercritical fluid by the pipe 1708 and the heat dissipations fins 1716 is dissipated in air. As it cools, the density of the supercritical fluid increases and, therefore, it tends to sink through the pipe toward the second opening 1718 and back into the housing 1702 (as generally indicate by 1718). In addition, the upward motion of hotter (less dense) portions of the supercritical fluid adjacent the first opening 1720 draws the cooler (denser) portions of the supercritical fluid through the second opening 1718 into the housing 1702, where the loop may repeat and continue cooling the heat-generating component 1704.

In some embodiments, the internal cavity within the heat-transfer device 1701 of FIG. 17 is an open cavity (e.g., similar to the internal cavity 110 of the heat-transfer device 101 in FIGS. 1, 2, and 3). In other embodiments, the internal cavity within the heat-transfer device 1701 includes fins (e.g., similar to the internal cavity 512 of the heat-transfer device 501 in FIGS. 5, 6, 7, and 8). In still other embodiments, the internal cavity within the heat-transfer device 1701 includes structural members (e.g., similar to the internal cavity 910 of the heat-transfer device 901 in FIGS. 9, 10, and 11). In other embodiments, the internal cavity within the heat-transfer device 1701 includes fins and structural members (e.g., similar to the internal cavity of the heat-transfer device 1202 in FIG. 12). In still other embodiments, the internal cavity within the heat-transfer device 1701 includes structural fins (e.g., similar to the internal cavity 1326 of the heat-transfer device 1301 in FIGS. 13, 14, and 5).

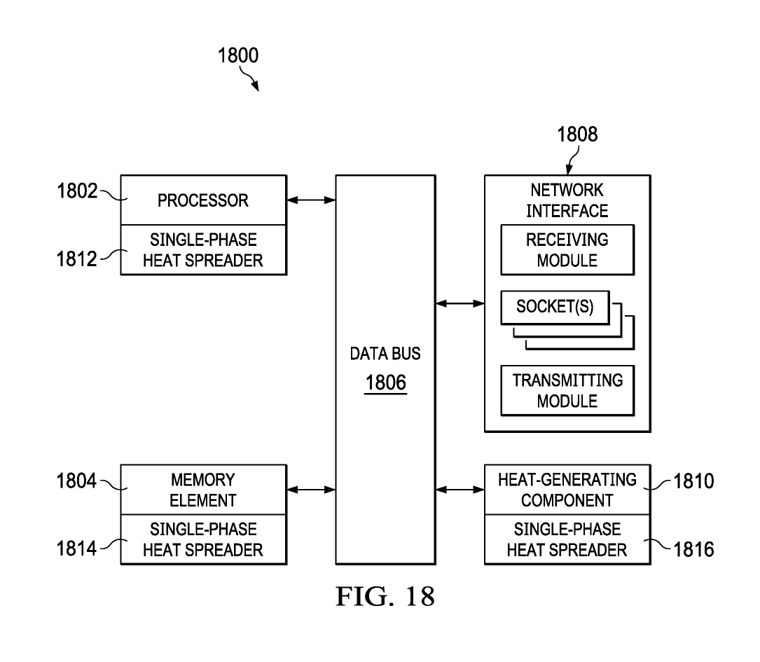

FIG. 18 is a simplified component diagram illustrating components of a computing device 1800 comprising heat-generating components and heat-transfer devices to cool the heat-generating components. The computing device 1800 comprises a processor 1802 for processing data, a memory element 1804 for storing data, a network interface 1808 for transmitting and receiving data over a network, and heat-generating component 1810, and a data bus 1806 facilitate communications between the other components, each of which may generate heat during operation. Thus, the computing device 1800 also comprises heat-transfer devices 1812, 1814, and 1816 to dissipate the heat generated by the heat-generating component. The heat-transfer device 1812 is coupled to the processor 1802. The heat-transfer device 1814 is coupled to the memory element 1804. The heat-transfer device 1816 is coupled to the heat-generating component 1810. The heat-transfer devices 1812, 1814, and 1816 may be any heat-transfer device disclosed herein. In one embodiment: the heat-transfer device 1812 is an example of the heat-transfer device 901 (of FIGS. 9, 10, and 11); the heat-transfer device 1814 is an example of the heat-transfer device 1701 (of FIG. 17); and heat-transfer device 1816 is an example of the heat-transfer device 1301 (of FIGS. 13, 14, and 15).

For clarity, FIG. 18 depicts a specific number of each of heat-transfer devices (e.g., the single-phase heat spreaders and heat-generating components (e.g., the processor 1802, the memory element 1804, the heat-generating component 1810)). However, any number of heat-spreader devices and heat generating components may be implemented in a system according to one or more embodiments of the present specification. As an example, a single (larger) heat-transfer device may be simultaneously coupled to (and dissipate heat from) more than one of the heat-generating components.

The following examples, pertain to some embodiments of the present disclosure.

Example 1 is an apparatus comprising: a housing forming an internal cavity; and a supercritical fluid enclosed in the internal cavity of the housing, wherein the supercritical fluid comprises a fluid in a supercritical state and the supercritical fluid is configured to transfer heat away from a heat-generating component while remaining in the supercritical state.

Example 2 includes the subject matter of Example 1, and may further comprise the supercritical fluid being configured to circulate in a closed loop within the internal cavity based on a change in density of a portion of the supercritical fluid.

Example 3 includes the subject matter of Example 3, and may further comprise the change in the density of the portion of the supercritical fluid being the density of the fluid decreasing by 10 kg/m³ or more for each degree Celsius of temperature increase.

Example 4 includes the subject matter of any one or more of Examples 1-3, and may further comprise the housing comprising at least two walls.

Example 5 includes the subject matter of Example 4, and may further comprise the at least two walls being oriented at an angle that is oblique to a horizontal plane.

Example 6 includes the subject matter of Example 4 and/or 5, and may further comprise a plurality of structural members coupling the at least two walls.

Example 7 includes the subject matter of any one or more of Examples 4-6, and may further comprise a plurality of fins within the internal cavity to direct flow of the supercritical fluid, wherein each of the plurality of fins extends from one of the at least two walls.

Example 8 includes the subject matter of Example 6, and may further comprise one of the plurality of structural members being an opening configured to facilitate flow of the supercritical fluid.

Example 9 includes the subject matter of any one or more of Examples 4-8, and may further comprise the at least two walls comprising: a heat-absorption wall configured to absorb heat from the heat-generating component; and at heat-dissipation wall configured to dissipate heat from the heat-generating component.

Example 10 includes the subject matter of Example 9, and may further comprise the heat-absorption wall comprising: an outer surface positioned proximate the heat-generating component; and an inner surface in contact with a first portion of the supercritical fluid.

Example 11 includes the subject matter of Example 9 and/or 10, and may further comprise the heat-dissipation wall comprising: an outer surface positioned distal the heat-generating component; and an inner surface in contact with a second portion of the supercritical fluid.

Example 12 includes the subject matter of any one or more of Examples 9-11, and may further comprise the first portion of the supercritical fluid comprising the fluid in the supercritical state having a first density and the second portion of the supercritical fluid comprising the fluid in the supercritical state having a second density.

Example 13 includes the subject matter of any one or more of Examples 4-12, and may further comprise the at least two walls being parallel to one another.

Example 14 includes the subject matter of any one or more of Examples 1-13, and may further comprise the supercritical fluid filling at least 95% of the internal cavity.

Example 15 includes the subject matter of any one or more of Examples 1-14, and may further comprise at least 95% of the supercritical fluid comprising the fluid in the supercritical state.

Example 16 includes the subject matter of any one or more of Examples 1-15, and may further comprise the housing further comprising a first opening and a second opening, each configured to facilitate flow of the supercritical fluid; and the apparatus further comprising: a pipe forming a closed loop between the first opening and the second opening, wherein the supercritical fluid is configured to circulate through the pipe based on a change in density of a portion of the supercritical fluid.

Example 17 includes the subject matter of Example 9, and may further comprise the apparatus being configured to absorb, using the fluid in the supercritical state, heat from the heat-generating component via the heat-absorption wall and to dissipate, using the fluid in the supercritical state, heat from the heat-generating component via the heat-dissipation wall.

Example 18 includes the subject matter of Example 17, and may further comprise the fluid being configured to remain in the supercritical state between absorption and dissipation.

Example 19 includes the subject matter of any one or more of Examples 1-18, and may further comprise a pressure of the fluid being above a critical pressure of the fluid.

Example 20 includes the subject matter of any one or more of Examples 1-19, and may further comprise a temperature of the fluid is above a critical temperature of the fluid.

Example 21 is a system comprising: a heat-generating component; a housing forming an internal cavity, wherein the housing is positioned proximate a heat-generating component; and a supercritical fluid enclosed in the internal cavity of the housing, wherein the supercritical fluid comprises a fluid in a supercritical state and the supercritical fluid is configured to transfer heat away from the heat-generating component while remaining in the supercritical state.

Example 22 includes the subject matter of Example 21, and may further comprise the supercritical fluid being configured to circulate in a closed loop within the internal cavity based on a change in density of a portion of the supercritical fluid.

Example 23 includes the subject matter of Example 23, and may further comprise the change in the density of the portion of the supercritical fluid being the density of the fluid decreasing by 10 kg/m³ or more for each degree Celsius of temperature increase.

Example 24 includes the subject matter of any one or more of Examples 21-23, and may further comprise the housing comprising at least two walls.

Example 25 includes the subject matter of Example 24, and may further comprise the at least two walls being oriented at an angle that is oblique to a horizontal plane.

Example 26 includes the subject matter of Example 24 and/or 25, and may further comprise a plurality of structural members coupling the at least two walls.

Example 27 includes the subject matter of any one or more of Examples 24-26, and may further comprise a plurality of fins within the internal cavity to direct flow of the supercritical fluid, wherein each of the plurality of fins extends from one of the at least two walls.

Example 28 includes the subject matter of Example 26, and may further comprise one of the plurality of structural members being an opening configured to facilitate flow of the supercritical fluid.

Example 29 includes the subject matter of any one or more of Examples 24-28, and may further comprise the at least two walls comprising: a heat-absorption wall configured to absorb heat from the heat-generating component; and at heat-dissipation wall configured to dissipate heat from the heat-generating component.

Example 30 includes the subject matter of Example 29, and may further comprise the heat-absorption wall comprising: an outer surface positioned proximate the heat-generating component; and an inner surface in contact with a first portion of the supercritical fluid.

Example 31 includes the subject matter of Example 29 and/or 30, and may further comprise the heat-dissipation wall comprising: an outer surface positioned distal the heat-generating component; and an inner surface in contact with a second portion of the supercritical fluid.

Example 32 includes the subject matter of any one or more of Examples 29-31, and may further comprise the first portion of the supercritical fluid comprising the fluid in the supercritical state having a first density and the second portion of the supercritical fluid comprising the fluid in the supercritical state having a second density.

Example 33 includes the subject matter of any one or more of Examples 24-32, and may further comprise the at least two walls being parallel to one another.

Example 34 includes the subject matter of any one or more of Examples 21-33, and may further comprise the supercritical fluid filling at least 95% of the internal cavity.

Example 35 includes the subject matter of any one or more of Examples 21-34, and may further comprise at least 95% of the supercritical fluid comprising the fluid in the supercritical state.

Example 36 includes the subject matter of any one or more of Examples 21-35, and may further comprise the housing further comprising a first opening and a second opening, each configured to facilitate flow of the supercritical fluid; and the apparatus further comprising: a pipe forming a closed loop between the first opening and the second opening, wherein the supercritical fluid is configured to circulate through the pipe based on a change in density of a portion of the supercritical fluid.

Example 37 includes the subject matter of Example 29, and may further comprise the apparatus being configured to absorb, using the fluid in the supercritical state, heat from the heat-generating component via the heat-absorption wall and to dissipate, using the fluid in the supercritical state, heat from the heat-generating component via the heat-dissipation wall.

Example 38 includes the subject matter of Example 37, and may further comprise the fluid being configured to remain in the supercritical state between absorption and dissipation.

Example 39 includes the subject matter of any one or more of Examples 21-38, and may further comprise a pressure of the fluid being above a critical pressure of the fluid.

Example 40 includes the subject matter of any one or more of Examples 21-39, and may further comprise a temperature of the fluid is above a critical temperature of the fluid.

Example 41 is a method comprising providing a housing, the housing forming an internal cavity; placing a fluid in the internal cavity, wherein the internal cavity encloses the fluid; and causing the fluid to transition to a supercritical fluid, wherein the supercritical fluid comprises the fluid in a supercritical state.

Example 42 includes the subject matter of Example 41, and may further comprise positioning the housing proximate a heat-generating component, the supercritical fluid is configured to transfer heat away from the heat-generating component while remaining in the supercritical state.

Example 43 includes the subject matter of any one or more of Examples 41-42, and may further comprise the supercritical fluid circulating in a closed loop within the internal cavity based on a change in density of a portion of the supercritical fluid.

Example 44 includes the subject matter of Example 43, and may further comprise the change in the density of the portion of the supercritical fluid comprising: decreasing the density of the fluid by 10 kg/m³ or more for each degree Celsius of temperature increase.

Example 45 includes the subject matter of any one or more of Examples 41-44, and may further comprise attaching at least two walls to one another produce the housing.

Example 46 includes the subject matter of Example 45, and may further comprise orienting the at least two walls at an angle that is oblique to a horizontal plane.

Example 47 includes the subject matter of Example 45 and/or 46, and may further comprise coupling a plurality of structural members to the at least two walls.

Example 48 includes the subject matter of any one or more of Examples 45-47, and may further comprise attaching a plurality of fins to the at least two walls within the internal cavity, wherein each of the plurality of fins extends from one of the at least two walls; and directing, by the plurality of fins, flow of the supercritical fluid.

Example 49 includes the subject matter of Example 48, and may further comprise one of the plurality of structural members being an opening configured to facilitate flow of the supercritical fluid.

Example 50 includes the subject matter of any one or more of Examples 45-49, and may further comprise the at least two walls comprising: a heat-absorption wall and at heat-dissipation wall; and absorbing, by the heat-absorption wall, heat from the heat-generating component; and dissipating, by the heat-dissipation wall, heat from the heat-generating component.

Example 51 includes the subject matter of Example 50, and may further comprise the heat-absorption wall comprising: an outer surface positioned proximate the heat-generating component; and an inner surface in contact with a first portion of the supercritical fluid.

Example 52 includes the subject matter of Example 50 and/or 51, and may further comprise the heat-dissipation wall comprising: an outer surface positioned distal the heat-generating component; and an inner surface in contact with a second portion of the supercritical fluid.

Example 53 includes the subject matter of any one or more of Examples 51-52, and may further comprise the first portion of the supercritical fluid comprising the fluid in the supercritical state having a first density and the second portion of the supercritical fluid comprising the fluid in the supercritical state having a second density.

Example 54 includes the subject matter of any one or more of Examples 45-53, and may further comprise the at least two walls being parallel to one another.

Example 55 includes the subject matter of any one or more of Examples 41-54, and may further comprise filling at least 95% of the internal cavity with the supercritical fluid.

Example 56 includes the subject matter of any one or more of Examples 41-55, and may further comprise maintaining, within the supercritical fluid, at least 95% of the fluid in the supercritical state.

Example 57 includes the subject matter of any one or more of Examples 41-56, and may further comprise creating a first opening and a second opening in the housing; forming, using a pipe, a closed loop between the first opening and the second opening; and circulating the supercritical fluid through the pipe based on a change in density of a portion of the supercritical fluid, wherein the supercritical fluid flows through first opening and the second opening.

Example 58 includes the subject matter of Example 50, and may further comprise absorbing, using the fluid in the supercritical state, heat from the heat-generating component via the heat-absorption wall; and dissipating, using the fluid in the supercritical state, heat from the heat-generating component via the heat-dissipation wall.

Example 59 includes the subject matter of Example 58, and may further comprise the fluid remaining in the supercritical state between absorption and dissipation.

Example 60 includes the subject matter of any one or more of Examples 41-59, and may further comprise applying a pressure to the fluid that is above a critical pressure of the fluid.

Example 61 includes the subject matter of any one or more of Examples 41-60, and may further imposing a temperature on the fluid that is above a critical temperature of the fluid.

Example 62 is an apparatus comprising means to perform a method as specified in any of Examples 41-61.

Example 63 is a machine-readable storage including machine-readable instructions, when executed, to implement a method or realize an apparatus as specified in any of Examples 1-62.

Example 64 is a machine readable medium including code, when executed, to cause a machine to perform the methods of any one of Examples 41-61.

Example 65 is an apparatus comprising: a processor; and a memory coupled to the processor to store instructions, the instructions, when executed by the processor, to perform the methods of any one of Examples 41-61.

What is claimed is:

1. An apparatus comprising:
a housing forming an internal cavity; and
a supercritical fluid enclosed in the internal cavity of the housing, wherein the supercritical fluid comprises a fluid in a supercritical state and the supercritical fluid is configured to transfer heat away from a heat-generating component while remaining in the supercritical state.

2. The apparatus of claim 1, wherein the supercritical fluid is configured to circulate in a closed loop within the internal cavity based on a change in density of a portion of the supercritical fluid.

3. The apparatus of claim 2, wherein the change in the density of the portion of the supercritical fluid comprises the density of the fluid decreasing by 10 kg/m³ or more for each degree Celsius of temperature increase.

4. The apparatus of claim 1, wherein the housing comprises at least two walls.

5. The apparatus of claim 4, further comprising a plurality of structural members coupling the at least two walls.

6. The apparatus of claim 4, further comprising a plurality of fins within the internal cavity to direct flow of the supercritical fluid, wherein each of the plurality of fins extends from one of the at least two walls.

7. The apparatus of claim 4, wherein the at least two walls comprise:
a heat-absorption wall configured to absorb heat from the heat-generating component; and
at heat-dissipation wall configured to dissipate heat from the heat-generating component.

8. The apparatus of claim 1, wherein a first portion of the supercritical fluid comprises the fluid in the supercritical state having a first density and a second portion of the supercritical fluid comprises the fluid in the supercritical state having a second density.

9. The apparatus of claim 1, wherein the supercritical fluid fills at least 95% of the internal cavity.

10. The apparatus of claim 1, wherein the housing further comprises a first opening and a second opening, each configured to facilitate flow of the supercritical fluid; and
wherein the apparatus further comprises:
a pipe forming a closed loop between the first opening and the second opening, wherein the supercritical fluid is configured to circulate through the pipe based on a change in density of a portion of the supercritical fluid.

11. The apparatus of claim 7, wherein the apparatus is configured to absorb, using the fluid in the supercritical state, heat from the heat-generating component via the heat-absorption wall and to dissipate, using the fluid in the supercritical state, heat from the heat-generating component via the heat-dissipation wall.

12. The apparatus of claim 11, wherein the fluid is configured to remain in the supercritical state between absorption and dissipation.

13. A system comprising:
a heat-generating component;
a housing forming an internal cavity, wherein the housing is positioned proximate a heat-generating component; and
a supercritical fluid enclosed in the internal cavity of the housing, wherein the supercritical fluid comprises a fluid in a supercritical state and the supercritical fluid is configured to transfer heat away from the heat-generating component while remaining in the supercritical state.

14. The system of claim 13, wherein the supercritical fluid is configured to circulate in a closed loop within the internal cavity based on a change in density of a portion of the supercritical fluid.

15. The system of claim 14, wherein the change in the density of the portion of the supercritical fluid comprises the density of the fluid decreasing by 10 kg/m³ or more for each degree Celsius of temperature increase.

16. The system of claim 13, wherein the housing comprises at least two walls.

17. The system of claim 16, further comprising a plurality of structural members coupling the at least two walls.

18. The system of claim 16, further comprising a plurality of fins within the internal cavity to direct flow of the supercritical fluid, wherein each of the plurality of fins extends from one of the at least two walls.

19. A method comprising:
providing a housing, the housing forming an internal cavity;
placing a fluid in the internal cavity, wherein the internal cavity encloses the fluid; and
causing the fluid to transition to a supercritical fluid, wherein the supercritical fluid comprises the fluid in a supercritical state.

20. The method of claim 19, further comprising: attaching at least two walls to one another produce the housing.
